(19) United States
(12) Patent Application Publication
(10) Pub. No.: US 2002/0052295 A1
(43) Pub. Date: May 2, 2002

(54) Diacyl derivatives of propylene diamine having herbicidal activity

(76) Inventors: Shridhar G. Hegde, Ballwin, MO (US); Daniel M. Krupa, Wildwood, MO (US); Joseph A. Bohn, St. Charles, MO (US); David L. Coffen, San Diego, CA (US); Gary R. Gustafson, Bedford, MA (US); Alan P. Kaplan, Watertown, MA (US); Yuting Ma, Veedhoe, MA (US)

Correspondence Address: Ira D. Finkelstein, HOWREY SIMON ARNOLD & WHITE, LLP, 750 Bering Drive, Houston, TX, 77057, US

(21) Appl. No.: 09/730,529

(22) Filed: Dec. 5, 2000

Related U.S. Application Data
(60) Provisional application No. 60/172,802, filed on Dec. 21, 1999.

(51) Int. Cl. A01N 57/00; A01N 43/56

(52) U.S. Cl. 504/128; 504/133; 504/130; 546/275.4; 548/370.1; 560/24

(57) ABSTRACT

Novel herbicidal compounds are provided having the formula (I)

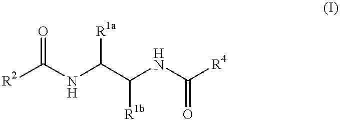

wherein one of R^{1a} and R^{1b} is a methyl, hydroxymethyl or monohalomethyl group and the other is hydrogen; R² is a group R³—(X¹)ₘ— where X¹ is a methylene, oxy or thio linkage, m is 0 or 1, and R³ is a substituted phenyl group of formula

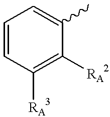

where R_{A}² is a hydrogen, halogen or methyl group and R_{A}³ is a halogen or halomethyl group; and R⁴ is an α-halo- or α,α-dihalo-(C₁₋₃)alkyl group or a group having the formula —(X²)ₙ—R⁵ where X² is a methylene, oxy or thio linkage, n is 0 or 1, and R⁵ is an optionally substituted five-member or six-member aromatic or heterocyclic ring.

### FIELD OF THE INVENTION

The present invention relates to a new class of compounds useful in agriculture and related industries. More specifically, the present invention relates to compounds which when applied to plants or the locus thereof are useful for killing, controlling growth of or eliciting symptoms of phytotoxicity in such plants. Further, the invention relates to methods of preparing such compounds, to compositions comprising such compounds, and to methods of killing, controlling or eliciting symptoms of phytotoxicity in plants with such compounds and compositions thereof.

### BACKGROUND OF THE INVENTION

It is well known that diacyl compounds can be prepared as derivatives of alkylene diamines, for example propylene diamine. However, with few exceptions such diacyl compounds have not previously been found to possess significant utility, particularly as agricultural chemicals.

U.S. Pat. No. 5,106,873 discloses a class of compounds, embracing without specifically disclosing diacyl derivatives of propylene diamine, said to be therapeutically useful as agents for preventing intestinal absorption of dietary cholesterol.

U.S. Pat. No. 5,360,808 discloses arylcarbonylaminoalkyl-dihydro-oxo-pyridines said to be therapeutically useful in treatment of cardiovascular disorders. Among compounds specifically disclosed are some that are substituted dihydro-1-[2-(3-pyridinylcarbonylamino)-1-methylethyl]-oxo-pyridines, and that could be considered derivatives of propylene diamine.

International Publication No. WO 97/29091 discloses a method for preparation of a combinatorial library of balanol derivatives as potential drug candidates. A class of diacyl derivatives of propylene diamine is encompassed but not specifically disclosed among compounds said to be capable of preparation by such a method.

It is an objective of the present invention to provide a class of diacyl derivatives of propylene diamine wherein can be identified a large number of compounds having biological activity useful in agriculture and related endeavors, particularly where such activity is manifested in plants as killing, controlling growth and/or appearance of symptoms of phytotoxicity. This and other objectives are satisfied by the invention described below.

### SUMMARY OF THE INVENTION

Now provided are novel compounds having the formula (I)

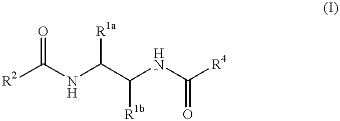

wherein one of R^{1a} and R^{1b} is a methyl, hydroxymethyl or monohalomethyl group and the other is hydrogen; R² is a group R³—(X¹)ₘ— where X¹ is a methylene, oxy or thio linkage, m is 0 or 1, and R³ is a substituted phenyl group of formula

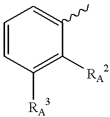

where R_{A}² is a hydrogen, halogen or methyl group and R_{A}³ is a halogen or halomethyl group; and R⁴ is as defined immediately below. Unless otherwise indicated herein, compounds of formula (I) are to be considered to include racemic mixtures and single enantiomers, as well as tautomers thereof.

R⁴ in a compound of formula (I) can be an α-halo- or α,α-dihalo-(C₁₋₃)alkyl group; alternatively R⁴ is a group having the formula —(X²)ₙ—R⁵ where X² is a methylene, oxy or thio linkage, n is 0 or 1, and R⁵ is a first five-member or six-member aromatic or heterocyclic ring. Such a ring has

(a) ring-substituents selected from the following list A: (i) hydrogen, (ii) halogen, (iii) cyano, (iv) nitro and (v) C,, aliphatic and alicyclic hydrocarbyl and halohydrocarbyl, phenyl, benzyl, phenylethyl and five-member or six-member heterocyclic groups attached to the first aromatic or heterocyclic ring either directly or by an oxy or thio linkage; wherein such phenyl, benzyl, phenylethyl or heterocyclic groups have ring substituents selected from hydrogen, halogen, methyl, halomethyl, methoxy, methylthio, halomethoxy and halomethylthio groups; and/or

(b) fused therewith a second five-member or six-member aromatic or heterocyclic ring having ring-substituents selected from list A as defined above.

However, no more than one ring substituent on the first and second five-member or six-member aromatic or heterocyclic rings is other than a hydrogen, halogen, methyl, methoxy or methylthio group.

More particularly, there are now provided compounds useful for killing, controlling growth of and/or eliciting symptoms of phytotoxicity in plants, these compounds being of formula (II)

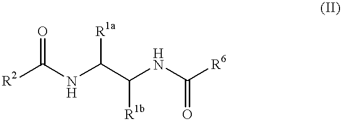

wherein R^{1a}, R^{1b} and R² are as defined hereinabove, and R⁶ is a group selected either from α-halo- and α,α-dihalo-(C₁₋₃)alkyl groups, or from groups having the formula —(X²)ₙ—R⁷ where X² is a methylene, oxy or thio linkage, n is 0 or 1, and R⁷ is

(a) a first aromatic or heterocyclic ring having the formula

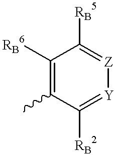

where

(1) Y is N or CR_{B}³ where R_{B}³ (i) is a hydrogen, cyano or nitro group; (ii) is a group selected from the following list B: halogen and C₁₋₆ aliphatic and alicyclic hydrocarbyl and halohydrocarbyl, phenyl, benzyl, phenylethyl and pyrazol-3-yl groups attached to the first aromatic or heterocyclic ring either directly or by an oxy or thio linkage, wherein such phenyl, benzyl or phenylethyl groups have ring substituents selected from hydrogen, halogen and methyl groups, no more than two such ring substituents being other than hydrogen and at least one o-substituent being hydrogen, and wherein such pyrazol-3-yl groups have the formula

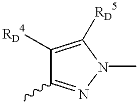

where one of R_{D}⁴ and R_{D}⁵ is a hydrogen or halogen group and the other is a halogen, methyl or halomethyl group; or (iii) forms with the adjacent moiety R_{B}² a second aromatic or heterocyclic ring, fused to the first aromatic or heterocyclic ring, this second ring being either a dihydrofuran ring or a phenyl or thiazole ring having substituents selected from hydrogen, halogen, methyl, ethyl, halomethyl, haloethyl, methoxy and ethoxy groups;

(2) Z is N or CR_{B}⁴ where R_{B}⁴ is a hydrogen, fluoro, chloro, fluoromethyl, chloromethyl or, except where n is 0, methyl, methoxy, fluoromethoxy or chloromethoxy group, with the proviso that no more than one of Y and Z is N;

(3) one of R_{B}² and R_{B}⁶ is hydrogen and the other is hydrogen or a group selected from list B as defined above; or R_{B}⁶ is hydrogen and R_{B}² forms with R_{B}³ a second aromatic or heterocyclic ring fused to the first aromatic or heterocyclic ring as defined above; and

(4) R_{B}⁵ is a hydrogen, fluoro or, where Z is N, chloro group;

with the proviso that no more than one of R_{B}², R_{B}³, R_{B}⁴, R_{B}⁵ and R_{B}⁶ comprises a phenyl or pyrazolyl ring, no more than one of R_{B}², R_{B}³, R_{B}⁴, R_{B}⁵ and R_{B}⁶ is a halomethyl group and, where n is 0, at least one of R_{B}², R_{B}³, R_{B}⁴, R_{B}⁵ and R_{B}⁶ is other than hydrogen;

(b) a pyrazol-4-yl or 1,2,3-triazol-4-yl ring having the formula

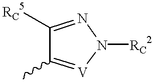

where V is N or CH, R_{C}² is a methyl or phenyl group and R_{C}⁵ is a group selected from list B as defined above with the proviso that where R_{C}² is methyl, R_{C}⁵ is other than a halogen or methyl group;

(c) an optionally substituted pyrazol-3-yl ring having the formula

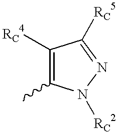

where R_{C}² is a methyl or phenyl group, one of R_{C}⁴ and R_{C}⁵ is a hydrogen or halogen group and the other is a group selected from list B as defined above with the proviso that where R_{C}² is methyl, one of R_{C}⁴ and R_{C}⁵ is other than a hydrogen, halogen or methyl group;

(d) an isoxazol-4-yl ring having the formula

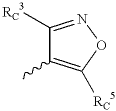

where one of R_{C}³ and R_{C}⁵ is a halomethyl group and the other is a group selected from list B as defined above but is not a halogen or methyl group;

(e) an oxazol-4-yl ring having the formula

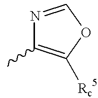

where R_{C}⁵ is a phenyl, benzyl or phenylethyl group having ring-substituents selected from hydrogen, halogen, methyl and halomethyl groups, no more than two such ring-substituents being other than hydrogen and at least one o-substituent being hydrogen; or

(f) a 1,3-thiazol-5-yl or 1,2,3-thiadiazol-5-yl ring having the formula

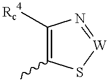

where W is N or CR_{C}² where R 2 is a group selected from list B as defined above, and R is a halogen, methyl or halomethyl group.

The present invention also provides methods of preparing compounds of formula (I) from propylene diamine, the compound of formula (III).

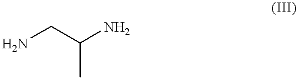

Certain of these methods employ a reaction of a type known in the art to form an amide linkage at the locus of each amine group in the compound of formula (III). In such methods, where both amine groups are simultaneously converted to amide linkages, the diacyl compound formed is a bis-amide compound of formula (II) wherein R² and R⁶ are identical. Such a compound is herein described for convenience as “symmetrical”, although it will be recognized that the R¹ group present in the diamine “core” of a molecule of the compound prevents the compound from being truly symmetrical.

Another method of preparing a compound of formula (I) or formula (II) comprises a first step of reacting the compound of formula (III) with a compound of formula (IV)

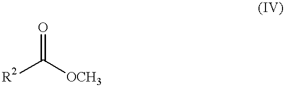

where R² is as defined above, to form an intermediate compound of formula (V)

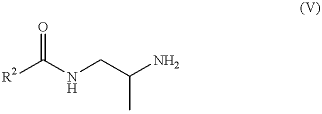

and a second step of reacting the intermediate compound with a compound of formula (VI)

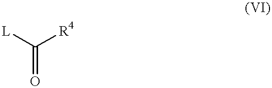

or formula (VII)

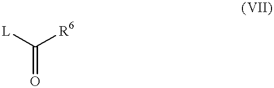

where L is a suitable leaving group and R⁴ and R⁶ are as defined hereinabove, to form a compound of formula (I) or formula (II) respectively. Depending on the choice of reagents (IV) and (VI), or reagents (IV) and (VII), the resulting compound can be symmetrical as defined above, or asymmetrical, i.e., having R² and R⁴, or R² and R⁶, groups that are not identical.

Suitable leaving groups for reagents to be reacted with diamines to form symmetrical compounds of the invention, or for reagents to be reacted with an intermediate compound of formula (V) to form a symmetrical or asymmetrical compound of the invention, are known to those of skill in the art and illustratively include —OH, —OCH₃ and —Cl groups. However, in the first step of the method described immediately above, it is important that the leaving group be —OCH₃ as shown in formula (IV), to promote preferential formation of an amide linkage on the less sterically hindered end of the diamine compound of formula (III).

Compounds having the formula (V) defined above are a further embodiment of the invention, being useful as intermediates in preparation of a wide range of diacyl compounds of formulas (I) or (II) where R^{1a} is hydrogen.

There is further provided a method involving a sequence of reactions of a type believed previously unknown in the art for preparing as a single R- or S-enantiomer an asymmetrical compound of the invention. To prepare the R-enantiomer, the starting reagent is benzyloxycarbonyl-D-alanine methyl ester; if the S-enantiomer is desired, the starting reagent is benzyloxycarbonyl-L-alanine methyl ester. The method is illustrated with regard to preparation of the R-enantiomer. Benzyloxycarbonyl-D-alanine methyl ester is first converted to the compound of formula (VIII)

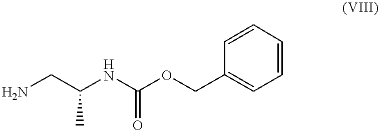

for example by reaction with ammonia to form benzyl-R-(2-amino-1-methyl-2-oxoethyl)carbamate followed by treatment of this compound with borane. The compound of formula (VIII) is then reacted with a compound of formula (IX)

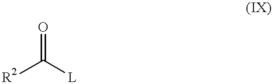

where L is a suitable leaving group and R² is as defined above, to form an intermediate compound of formula (X)

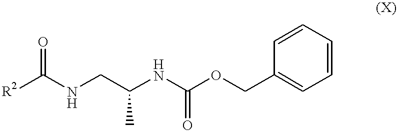

which retains the benzyloxycarbonyl group present in the starting reagent. This benzyloxycarbonyl group is next removed by hydrogenation, for example using a palladium-on-carbon catalyst, to form the R-enantiomer of an intermediate compound of formula (V) above, which is then reacted as described above with a compound of formula (VI) or (VII) to provide the R-enantiomer of a compound of formula (I) or (II) respectively.

The present invention also provides a composition for application to plants or the locus thereof as a herbicide, plant growth regulator or elicitor of symptoms of phytotoxicity, comprising a compound of formula (I), more particularly a compound of formula (II). Such a composition can be an application composition, further comprising water or other agriculturally acceptable liquid carrier, suitable for direct application to plants or the locus thereof. Alternatively, it can be a concentrate formulation, further comprising one or more agronomically acceptable inert formulation ingredients or excipient substances and suitable for dilution in water or other agriculturally acceptable liquid carrier to form an application composition.

The present invention also provides a method of using a compound of formula (I), more particularly a compound of formula (II), as an agent for killing, controlling growth of or eliciting symptoms of phytotoxicity in plants, comprising applying a herbicidally effective amount of such a compound to the plants or the locus thereof, including to a medium containing viable seeds of the plants or in which the plants are growing.

### DETAILED DESCRIPTION OF THE INVENTION

Preferred Compounds of Formula (III)

In compounds of the invention as defined in formula (II) above, the following substitutions are among those presently preferred.

Preferably R^{1a} is hydrogen and R^{1b} is a methyl group.

Preferably R² is a group

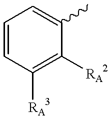

(i.e., m is preferably 0). In such a group R_{A}² is preferably hydrogen, fluorine or chlorine and R_{A}³ is preferably fluorine, chlorine or a trifluoromethyl group. In one especially preferred embodiment R_{A}² is hydrogen or fluorine and R_{A}³ is a trifluoromethyl group. In another especially preferred embodiment R_{A}² and R_{A}³ are each chlorine.

In a first preferred embodiment R⁶ is an α-halo- or α,α-dihalo-(C₁₋₃)alkyl group.

In a second preferred embodiment R⁶ is a substituted phenyl ring having the formula

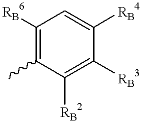

where

(a) R_{B}³ is (i) a group selected from hydrogen, halogen, cyano, nitro, methyl, halomethyl, phenyl, methoxy, methylthio, isobutoxy, halomethoxy, haloethoxy, phenoxy and pyrazol-3-yloxy groups, such pyrazol-3-yloxy groups comprising a substituted pyrazol-3-yl ring having the formula

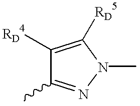

where one of R_{D}⁴ and R_{D}⁵ is a halogen group and the other is a halomethyl group; or (ii) forms with R_{B}² a dihydrofuran, optionally halogen-substituted phenyl, or thiazole ring fused to the phenyl ring;

(b) R_{B}⁴ is a hydrogen, halogen or trifluoromethyl group; and

(c) one of R_{B}² and R_{B}⁶ is hydrogen and the other is a group selected from hydrogen, halogen, methyl, halomethyl, phenyl, benzyl, phenylethyl, Cl 4 hydrocarbyloxy, hydrocarbylthio and halohydrocarbylthio, optionally 4-chloro- or 4-methyl-substituted phenoxy and phenylthio, benzoxy and pyrazol-3-yloxy groups, such pyrazol-3-yloxy groups comprising a substituted pyrazol-3-yl ring having the formula shown above; or R_{B}⁶ is hydrogen and R_{B}² forms with R_{B}³ said dihydrofuran, optionally halogen-substituted phenyl, or thiazole ring fused to the phenyl ring.

In a third preferred embodiment R⁶ is a group having the formula —X²—R⁷ where X² is a methylene or oxy linkage and R⁷ is a substituted or unsubstituted phenyl ring having the formula

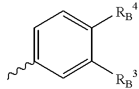

where R_{B}³ is a hydrogen, methoxy or trifluoromethyl group and R_{B}⁴ is a hydrogen or halogen group.

In a fourth preferred embodiment R⁶ is a substituted pyridine ring having the formula

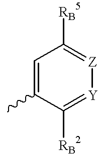

where

(a) if Z is N, Y is CR_{B}³ where R_{B}³ is a chloro or methyl group or forms with R_{B}² a phenyl ring fused to the pyridine ring, R_{B}², except where it forms part of such phenyl ring, is hydrogen, and R_{B}⁵ is a hydrogen or chloro group; and

(b) if Y is N, Z is CR_{B}⁴ where R_{B}⁴ is a hydrogen or chloro group, R_{B}² is selected from hydrogen, chloro, C₁₋₄ alkoxy, C₁₋₄ hydrocarbylthio and optionally 4-chloro- or 4-methyl-substituted phenoxy and phenylthio groups, and R_{B}⁵ is a hydrogen, chloro or bromo group, with the proviso that, except where R_{B}² and R_{B}⁵ are both chloro groups, only one of R_{B}², R_{B}⁴ and R_{B}⁵ is other than hydrogen.

In a fifth preferred embodiment R⁶ is a substituted pyrazol-4-yl or 1,2,3-triazol-4-yl ring having the formula

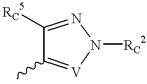

where V is N or CH, R_{C}² is a methyl or phenyl group and R_{C}⁵ is a methyl or halomethyl group.

In a sixth preferred embodiment R⁶ is a substituted pyrazol-3-yl ring having the formula

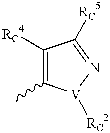

where R_{C}² is a methyl or phenyl group, R_{C}⁴ is a hydrogen or halogen group and R_{C}⁵ is a methyl, halomethyl or tert-butyl group.

In a seventh preferred embodiment R⁶ is a substituted isoxazol-4-yl ring having the formula

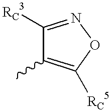

where R_{C}³ is a methyl or halomethyl group and R_{C}⁵ is a chloro, ethyl or optionally halogen- or halomethyl-substituted phenyl group.

In an eighth preferred embodiment R⁶ is a substituted oxazol-4-yl ring having the formula

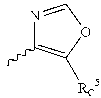

where R_{C}⁵ is a methyl or halomethyl group.

In a ninth preferred embodiment R⁶ is a substituted 1,3-thiazol-5-yl or 1,2,3-thiadiazol-5-yl ring having the formula

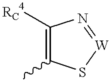

where, if W is N, R_{C}⁴ is a methyl group; and if W is CR_{C}², R_{C}² is a halogen, methyl, isopropyl, phenyl, halomethyl or methoxy group and R_{C}⁴ is a halogen, methyl or trifluoromethyl group.

Particularly preferred substitutions will be apparent from the specific illustrative examples given hereinbelow.

Preparation of Compounds of Formula (I) or (II)

The following preparation Methods A-J are illustrated by reference to particular compounds of the invention. However, it will be understood that the methods are generalizable to a wide range of compounds of the invention by appropriate selection of reagent compounds having the desired R² and R⁴, or R² and R⁶, groups. It will also be understood that changes made in details of any of Methods A-J by those of skill in the art while still providing the identified end product do not remove such method from the scope of the present invention.

Method A

This method is illustrated by preparation of N,N′-(1,2-propanediylbis)-3-(trifluoromethyl)benzamide, which is the compound of Example 5 herein. Method A is generally applicable to preparation of symmetrical diacyl compounds of formulas (I) or (II), where such compounds are to be prepared as racemic mixtures. The method involves a reaction that can be summarized:

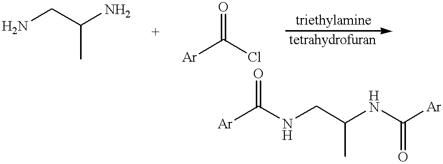

where Ar represents a suitable aryl group.

To a solution of 74 mg (1 mmol) 1,2-diaminopropane (propylene diamine) and 2 ml triethylamine in 10 ml tetrahydrofuran is added 416 mg (2 mmol) 3-(trifluoromethyl)benzoyl chloride. The resulting mixture is stirred at room temperature for 16 h. The mixture is evaporated and the residue partitioned between 20 ml ethyl acetate and 20 ml 2N hydrochloric acid solution to isolate an organic layer. The organic layer is washed with saturated sodium bicarbonate solution, dried over MgSO₄ and evaporated. The resulting white solid is stirred with 20 ml of a 1:1 mixture of ether and hexane, and is then filtered and air-dried to provide 305 mg (73% yield) N,N′-(1,2-propanediylbis)-3-(trifluoromethyl)benzamide: ¹H NMR (CDCl₃) δ 1.42 (3H, d, J=6 Hz), 3.57 (1H, m), 3.75 (1H, m), 4.42 (1H, m), ), 7.07 (1H, d, J=5 Hz), 7.58 (2H, t, J=7 Hz), 7.77 (2H, d, J=7 Hz), 7.98 (2H, d, J=7 Hz), 8.08 (2H, s).

Method B

This method is illustrated by preparation of R—N,N′-(1,2-propanediylbis)-3-(trifluoromethyl)benzamide, which is the compound of Example 5a herein. Method B is generally applicable to preparation of symmetrical diacyl compounds of formulas (I) or (II), where such compounds are to be prepared as the R-enantiomer. The method involves a sequence of reactions that can be summarized:

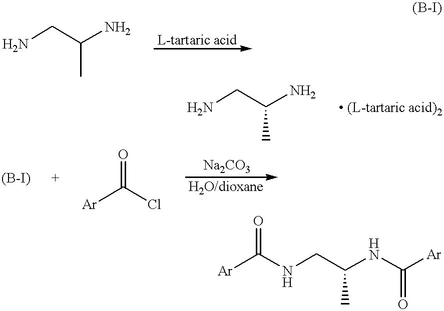

where Ar represents a suitable aryl group.

To a solution of 176 g (470.6 mmol) R-1,2-diaminopropane tartrate salt in 1 liter water is added 74 g (1850 mmol) sodium hydroxide in 50 ml water, 111 g (1047 mmol) sodium carbonate and 350 ml dioxane. With stirring, 218.5 g (1047 mmol) 3-(trifluoromethyl)benzoyl chloride is then added slowly at 0° C. and the resulting mixture is stirred at room temperature for about 16 h. Water is added and the mixture is extracted with methylene chloride and ethyl acetate (2 liters). The resulting organic layer is successively washed with 5% aqueous hydrochloric acid solution, saturated sodium bicarbonate solution and water, then dried over Na₂SO₄ and evaporated to give a white solid. This is then recrystallized from a 1:1 mixture of ether and hexane to provide 170 g R—N,N′-(1,2-propanediylbis)-3-(trifluoromethyl)benzamide: ¹H NMR (CDCl₃) δ 1.42 (3H, d, J=6 Hz), 3.57 (1H, m), 3.75 (1H, m), 4.42 (1H, m), 7.07 (1H, d, J=5 Hz), 7.58 (2H, t, J=7 Hz), 7.77 (2H, d, J=7 Hz), 7.98 (2H, d, J=7 Hz), 8.08 (2H, s); α_{D}=−28.8° (ethanol, c=0.5).

Method C

This method is illustrated by preparation of 2-ethylthio-N-[1-methyl-2-(3-trifluoromethyl)phenylcarbonylamino]ethyl-3-pyridinecarboxamide, which is the compound of Example 243 herein. Method C is generally applicable to preparation of asymmetrical diacyl compounds of formulas (I) or (II), where such compounds are to be prepared as racemic mixtures. The method involves a sequence of reactions that can be summarized:

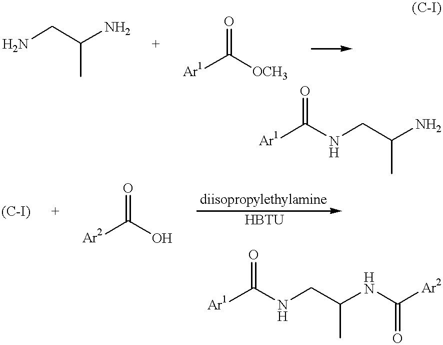

where Ar¹ and Ar² represent suitable aryl groups. If desired, Ar¹ or more preferably Ar² can be replaced by a non-aryl group, for example an α-halo- or α,α-dihalo-(C₁₋₃)alkyl group.

In a first step of Method C as illustrated here, N-(2-amino-1-propyl)-3-(trifluoromethyl)benzamide is prepared as an intermediate. A mixture of 4.1 g (20 mmol) methyl 3-(trifluoromethyl)benzoate and 5.9 g (80 mmol) 1,2-diaminopropane is stirred at room temperature for 24 h, and is then placed under high vacuum (0.1 mm Hg) and stirred at room temperature for a further 24 h to remove by volatilization excess 1,2-diaminopropane. The resulting gummy solid is triturated with 50 ml of a 1:1 mixture of ether and hexane, followed by filtration to give a white solid. Recrystallization of the crude product from ether-hexane gives 3.6 g (65% yield) N-(2-amino-1-propyl)-3-(trifluoromethyl)benzamide as a white crystalline material: ¹H NMR (DMSO-d₆) δ 0.98 (3H, d, J=7 Hz), 2.95 (1H, m), 3.18 (2H, m), 3.43 (1H, br s), 7.70 (2H, t, J=7 Hz), 7.88 (1H, d, J=7 Hz), 8.18 (2H, m), 8.68 (1H, br s).

In a second step of Method C as illustrated here, 2-ethylthio-N-[1-methyl-2-(3-trifluoromethyl)phenylcarbonylamino]ethyl-3-pyridinecarboxamide is prepared from the intermediate produced in the first step. A mixture of 0.85 g (3.45 mmol) N-(2-amino-1-propyl)-3-(trifluoromethyl) benzamide prepared as above, 0.63 g (3.45 mmol) 2-(ethylthio)pyridine-3-carboxylic acid, 1.31 g (3.45 mmol) HBTU (o-benzotriazol-1-yl-N,N,N′,N′-tetramethyluronium hexafluorophosphate) and 0.9 g (6.9 mmol) N,N-diisopropylethylamine in 4 ml dimethylformamide is stirred at 0° C. for 1 h and then at room temperature for 18 h. The mixture is then diluted with 10 ml water and extracted with methylene chloride (2×10 ml). The combined resulting organic layers are successively washed with 5% aqueous hydrochloric acid solution, saturated sodium bicarbonate solution and water, then dried over Na₂SO₄ and evaporated to give a solid. This solid is recrystallized from a mixture of hexane and ethyl acetate to give 0.77 g 2-ethylthio-N-[1-methyl-2-(3-trifluoromethyl) phenylcarbonylamino]ethyl-3-pyridinecarboxamide: ¹H NMR (CDCl₃) δ 1.28 (3H, t, J=7 Hz), 1.40 (3H, d, J=6 Hz), 3.16 (2H, m), 3.65 (2H, m), 4.48 (1H, m), 6.60 (1H, d, J=4 Hz), 7.04 (1H, t, J=5 Hz), 7.54 (2H, overlapping), 7.78 (2H, overlapping), 8.02 (1H, d, J=7 Hz), 8.14 (1H, s), 8.48 (1H, d, J=5 Hz).

Method D

This method is illustrated by preparation of 2-chloro-4-(trifluoromethyl)-N-[1-methyl-2-(3-trifluoromethyl)phenylcarbonylamino]ethyl-5-thiazolecarboxamide, which is the compound of Example 269 herein. Method D is generally applicable to preparation of asymmetrical diacyl compounds of formulas (I) or (II), where such compounds are to be prepared as racemic mixtures, and is a variant of Method C above. The method involves a sequence of reactions that can be summarized:

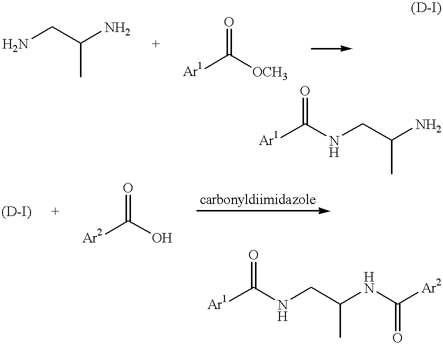

where Ar¹ and Ar² represent suitable aryl groups. If desired, Ar¹ or more preferably Ar² can be replaced by a non-aryl group, for example an α-halo- or α,α-dihalo-(C₁₋₃)alkyl group.

In a first step of Method D as illustrated here, N-(2-amino-1-propyl)-3-(trifluoromethyl)benzamide is prepared as an intermediate, exactly as in Method C above.

In a second step of Method D as illustrated here, 2-chloro-4-(trifluoromethyl)-N-[1-methyl-2-(3-trifluoromethyl)phenylcarbonylamino]ethyl-5-thiazolecarboxamide is prepared from the intermediate produced in the first step. To a suspension of 230 mg (1 mmol) 2-chloro-4-(trifluoromethyl)-5-thiazolecarboxylic acid in 6 ml dry acetonitrile is added 162 mg (1 mmol) carbonyldiimidazole in 2 ml dry acetonitrile, and the mixture is stirred at room temperature for 30 min. To the resulting clear solution is added 195 mg (0.8 mmol) N-(2-amino-1-propyl)-3-(trifluoromethyl) benzamide prepared as above, and the mixture is stirred at room temperature for 16 h. The mixture is then evaporated and the residue partitioned between 20 ml ethyl acetate and 20 ml water. The resulting organic layer is washed successively with dilute hydrochloric acid solution and saturated sodium bicarbonate solution, then dried over MgSO₄ and evaporated. The resulting oily residue is triturated with 1:1 ether-hexane to give a pale yellow solid which is collected by filtration and air-dried to provide 264 mg (72% yield) 2-chloro-4-(trifluoromethyl)-N-[1-methyl-2-(3-trifluoromethyl)phenylcarbonylamino]ethyl-5-thiazolecarboxamide: ¹H NMR (DMSO-d₆) δ 1.24 (3H, d, J=6 Hz), 3.48 (2H, m), 3.99 (1H, m), 7.24 (m, 2H), 7.58 (1H, t, J=7 Hz), 8.06 (1H, d, J=7 Hz), 8.15 (1H, s).

Method E

This method is illustrated by preparation of 1-methyl-N-[1-methyl-2-(3-trifluoromethyl)phenylcarbonylamino]ethyl-3-(trifluoromethyl)-4-pyrazolecarboxamide, which is the compound of Example 257 herein. Method E is generally applicable to preparation of asymmetrical diacyl compounds of formulas (J) or (II), where such compounds are to be prepared as racemic mixtures, and is a variant of Method C above. The method involves a sequence of reactions that can be summarized:

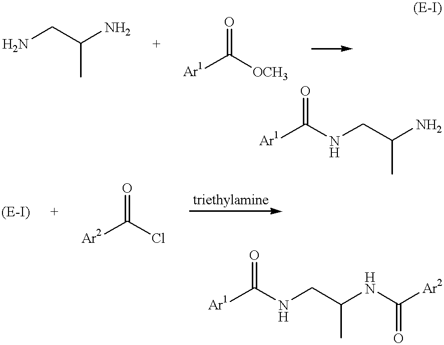

where Ar¹ and Ar² represent suitable aryl groups. If desired, Ar¹ or more preferably Ar² can be replaced by a non-aryl group, for example an α-halo- or α,α-dihalo-(C₁₋₃)alkyl group. Method E is generally suitable if the desired acid chloride reagent (Ar²COCl) is available as a stable compound having acceptable handling properties; otherwise Methods C or D can be used.

In a first step of Method E as illustrated here, N-(2-amino-1-propyl)-3-(trifluoromethyl)benzamide is prepared as an intermediate, exactly as in Method C above.

In a second step of Method E as illustrated here, 1-methyl-N-[1-methyl-2-(3-trifluoromethyl)phenylcarbonylamino]ethyl-3-(trifluoromethyl)-4-pyrazolecarboxamide is prepared from the intermediate produced in the first step. To a solution of 246 mg (1 mmol) N-(2-amino-1-propyl)-3-(trifluoromethyl)benzamide prepared as above and 2 ml triethylamine in 25 ml methylene chloride is added 212 mg (1 mmol) 1-methyl-3-(trifluoromethyl)-4-pyrazolecarbonyl chloride in 2 ml methylene chloride, and the mixture is stirred at room temperature for 16 h. The reaction mixture is then evaporated and the residue is washed successively with dilute hydrochloric acid solution and saturated sodium bicarbonate solution, then dried over MgSO₄ and evaporated. The resulting oily residue is triturated with 1:1 ether-hexane to give a white solid which is colected by filtration and air-dried to provide 312 mg (74% yield) 1-methyl-N-[1-methyl-2-(3-trifluoromethyl)phenylcarbonylamino]ethyl-3-(trifluoromethyl)-4-pyrazolecarboxamide: ¹H NMR (DMSO-d₆) δ 1.28 (3H, d, J=6 Hz), 3.2 (3H, s), 3.48 (2H, m), 3.99 (1H, m), 7.24 (m, 2H), 7.58 (1H, t, J=7 Hz), 8.06 (1H, d, J=7 Hz), 8.15 (1H, s), 8.35 (1H, s).

Method F

This method is illustrated by preparation of R-2,3-difluoro-N-[1-methyl-2-(3-trifluoromethyl)phenylcarbonylamino]ethylbenzamide, which is the compound of Example 34a herein. Method F is generally applicable to preparation of asymmetrical diacyl compounds of formulas (I) or (II), where such compounds are to be prepared as single R- or S-enantiomers. The method involves a sequence of reactions that can be summarized:

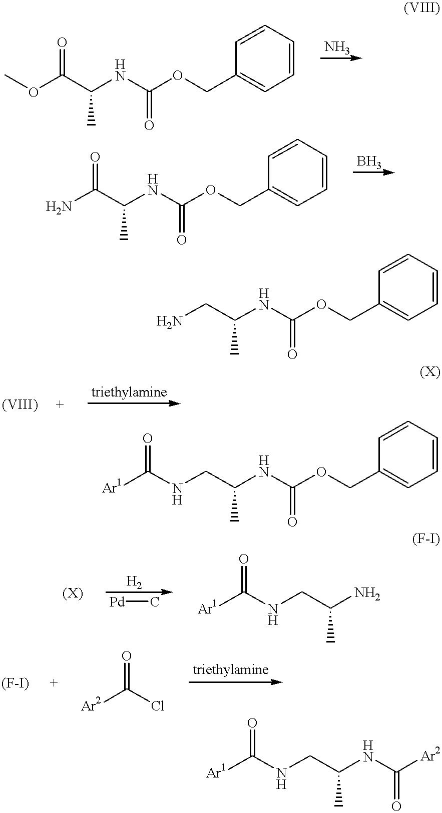

where Ar¹ and Ar² represent suitable aryl groups. If desired, Ar¹ or more preferably Ar² can be replaced by a non-aryl group, for example an α-halo- or α,α-dihalo-(C₁₋₃)alkyl group.

In a first step of Method F as illustrated here, benzyl R-(2-amino-1-methyl-2-oxoethyl)carbamate is prepared as a first intermediate. A mixture of 13.3 g (56.1 mmol) N-(benzyloxycarbonyl)-D-alanine methyl ester and 112 ml (224 mmol) of a 2M solution of ammonia in methanol is stirred at room temperature for 7 days. The resulting solution is then evaporated to give a solid (10.9 g) which is recrystallized from hexane-ethyl acetate mixture to provide benzyl R-(2-amino-1-methyl-2-oxoethyl)carbamate: ¹H NMR (DMSO-d₆) δ 1.22 (3H, d, J=6 Hz), 3.98 (1H), 5.03 (2H, s), 6.95 (1H, br s), 7.38 (5H, s).

In a second step of Method F as illustrated here, benzyl R-(2-amino-1-methylethyl)carbamate, the compound of formula (VIII), is prepared as a second intermediate. A 1M solution of borane in tetrahydrofuran (540.5 ml, 540.5 mmol) is added to 40 g (180.2 mmol) benzyl R-(2-amino-1-methyl-2-oxoethyl)carbamate prepared as above, and the resulting mixture is heated at reflux for 40 min. After cooling to room temperature, 50 ml methanol is added carefully and the mixture is again heated at reflux for 30 min. The resulting solution is then evaporated and the residue partitioned between methylene chloride (1.5 liters) and water (1 liter). The resulting organic layer is washed with water, dried over Na₂SO₄, and evaporated to give 49.6 g of benzyl R-(2-amino-1-methylethyl)carbamate as a white solid: ¹H NMR (DMSO-d₆) δ 1.01 (3H, d, J=6 Hz), 3.36 (3H, m), 5.01 (2H, s), 7.32 (5H, s).

In a third step of Method F as illustrated here, R—N-(2-amino-1-propyl)-3-(trifluoromethyl)benzamide is prepared as a third intermediate. A mixture of 1.32 g (6.35 mmol) benzyl R-(2-amino-1-methylethyl)carbamate prepared as above, 1.46 g (6.98 mmol) 3-(trifluoromethyl)benzoyl chloride and 1.29 g (12.7 mmol) triethylamine in 40 ml methylene chloride is stirred at room temperature for 2 days. Additional methylene chloride is added to dissolve precipitated solids and the resulting solution is successively washed with 5% aqueous hydrochloric acid solution, saturated sodium bicarbonate solution and water, dried over Na₂SO₄, and evaporated. The residue is purified by chromatography over silica gel using 30% ethyl acetate-hexane as eluent to give 1.12 g of a white solid: ¹H NMR (CDCl₃) δ 1.28 (3H, d, J=6 Hz), 3.52 (2H, m), 4.05 (1H, m), 4.14 (1H, m), 5.10 (2H, s), 7.31 (5H, s), 7.40(1H, s), 7.55 (1H, t, J=7 Hz), 7.76(1H, d, J=7 Hz), 7.93 (1H, d, J=7 Hz), 8.12 (1H, s). A mixture of this material (1.12 g (2.95 mmol) and 400 mg of 10% palladium-on-carbon in 20 ml methanol is hydrogenated at 276 kPa for 2 h and then filtered through a celite pad. The filtrate is evaporated to give 818 mg R—N-(2-amino-1-propyl)-3-(trifluoromethyl)benzamide as a white solid: ¹H NMR (DMSO-d₆) δ 0.98 (3H, d, J=7 Hz), 2.95 (1H, m), 3.18 (2H, m), 3.43 (1H, br s), 7.70 (2H, t, J=7 Hz), 7.88 (1H, d, J=7 Hz), 8.18 (2H, m), 8.68 (1H, br s).

In a fourth step of Method F as illustrated here, R-2,3-difluoro-N-[1-methyl-2-(3-trifluoromethyl)phenylcarbonylamino]ethylbenzamide is prepared from the third intermediate. A mixture of R—N-(2-amino-1-propyl)-3-(trifluoromethyl)benzamide (310 mg, 1.26 mmol) prepared as above, 2,3-difluorobenzoyl chloride (222 mg, 1.26 mmol) and triethylamine (191 mg, 1.89 mmol) in methylene chloride (10 ml) is stirred at room temperature for 24 h. Further methylene chloride is added and the resulting mixture is successively washed with 5% aqueous hydrochloric acid solution, saturated sodium bicarbonate solution and water, dried over Na₂SO₄, and evaporated. Recrystallization of the residue from hexane-ethyl acetate mixture gives 431 mg R-2,3-difluoro-N-[1-methyl-2-(3-trifluoromethyl)phenylcarbonylamino]ethylbenzamide as a white solid: ¹H NMR (CDCl₃) δ 1.4 (3H, d), 3.65 (2H, t), 4.5 (1H, m), 6.9 (1H, t), 7.2 (1H, m), 7.3 (1H, m), 7.55 (1H, t), 7.6 (1H, t), 7.8 (1H, d), 7.9 (1H, d), 8.1 (1H, s).

Method G

This method is illustrated by preparation of R-2-ethoxy-3-fluoro-N-[1-methyl-2-(3-trifluoromethyl) phenylcarbonylamino]ethylbenzamide], which is the compound of Example 41 herein. Method G uses as a starting material a compound of formula

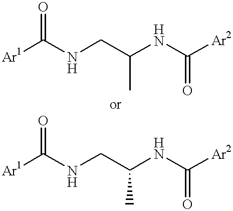

of the invention as prepared by any appropriate method herein described, wherein one or both of Ar¹ and Ar² are 2,3-difluorophenyl or 2-fluoro-3-(trifluoromethyl)phenyl groups, and involves nucleophilic substitution of the 2-fluoro substituent in one or both of Ar¹ and Ar².

To a solution of 0.21 g (0.544 mmol) R-2,3-difluoro-N-[1-methyl-2-(3-trifluoromethyl)phenylcarbonylamino]ethylbenzamide, the compound of Example 34a prepared by Method F as described above, is added 306 μl of 21% sodium ethoxide in ethanol (1.09 mmol), and the mixture is heated at 55° C. for 3 h and then evaporated to dryness. The residue is dissolved in ethyl acetate, and the resulting solution is washed successively with water and brine, then dried over Na₂SO₄, and evaporated to give 0.211 g (94% yield) R-2-ethoxy-3-fluoro-N-[1-methyl-2-(3-trifluoromethyl) phenylcarbonylamino]ethylbenzamide as a pale yellow solid: ¹H NMR (CDCl₃) δ 1.41 (3H, d), 1.45 (3H, t), 3.53 (1H, m), 3.67 (1H, m), 4.28 (2H, q), 4.50 (1H, m), 7.12 (1H, m), 7.22 (1H, m), 7.55 (1H, t), 7.72 (1H, d), 7.91 (1H, d), 8.01 (1H, d), 8.06 (1H, br), 8.15 (1H, s), 8.26 (1H, d).

Method H

This method is illustrated by preparation of N,N′-(3-hydroxy-1,2-propanediylbis)-3-(trifluoromethyl) benzamide, which is the compound of Example 11 herein, and N,N′-(3-chloro-1,2-propanediylbis)-3-(trifluoromethyl)benzamide, which is the compound of Example 12 herein. Method H is generally applicable to preparation of symmetrical diacyl compounds of formulas (I) or (II) wherein R^{1a} or R^{1b} is a hydroxymethyl or chloromethyl group. The method involves a first reaction that can be summarized:

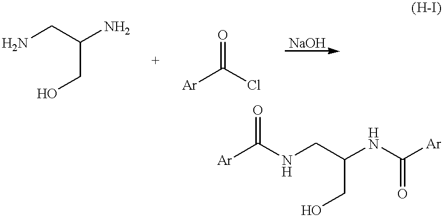

and an optional second reaction that can be summarized:

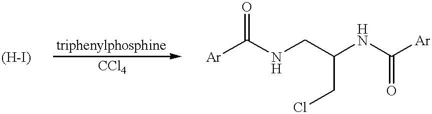

where Ar represents a suitable aryl group.

In a first step of Method H as illustrated here, 2.7 ml (17.9 mmol) 3-trifluoromethylbenzoyl chloride is added dropwise to a solution of 0.87 g (5.34 mmol) 2,3-diaminopropanol dihydrochloride in 10 ml water and 13.5 ml 2.5N sodium hydroxide, at 0° C. with vigorous stirring. The reaction mixture is then stirred at room temperature for a further 2 h and the resulting solid is isolated by filtration and dissolved in ethyl acetate, followed by drying over Na₂SO₄. The dried material is filtered and concentrated to provide 2.75 g of a white solid. A solution of 1 g of this crude product in 10 ml methanol is prepared, to which is added 2.5 ml water and 0.377 ml of 25% sodium hydroxide solution, followed by stirring for 1 h. The solution is concentrated and the residue partitioned between ethyl acetate and water. The resulting organic phase is dried over Na₂SO₄, filtered and concentrated. Purification of the residue by reverse phase HPLC (water/acetonitrile) gives 0.55 g N,N′-(3-hydroxy-1,2-propanediylbis)-3-(trifluoromethyl)benzamide as a white solid: OH NMR (CDCl₃) δ 3.7-3.9 (m, 4H), 4.26 (m, 1H), 7.94 (t, 2H), 7.72 (d, 2H), 7.50 (q, 2H) 8.06 (d, 2H). This is the compound of Example 11.

In a second step of method H as illustrated here, 0.242 g (0.92 mmol) triphenylphosphine is added to 0.2 g (0.46 mmol) N,N′-(3-hydroxy-1,2-propanediylbis)-3-(trifluoromethyl)benzamide prepared as above, in 0.8 ml chloroform and 0.5 ml carbon tetrachloride. The mixture is heated at 65° C. for 2 h and then concentrated. The resulting residue is triturated with 60% aqueous ethanol and the crude product is isolated by filtration. Purification of the crude product by reverse phase HPLC (water/acetonitrile) gives 0.135 g N,N′-(3-chloro-1,2-propanediylbis)-3-(trifluoromethyl)benzamide: ¹H NMR (CDCl₃) δ 3.72 (m, 1H), 3.84 (dd, 1H), 4.02 (m, 1H), 3.60 (dd, 1H), 4.49 (m, 1H), 7.55 (dt, 2H), 7.75 (t, 2H), 7.97 (t, 2H), 8.08 (d, 2H). This is the compound of Example 12.

Method I

This method is illustrated by preparation of N,N′-(3-fluoro-1,2-propanediylbis)-3-(trifluoromethyl) benzamide, which is the compound of Example 10 herein. Method I is generally applicable to preparation of symmetrical diacyl compounds of formulas (I) or (II) wherein R^{1a} or R^{1b} is a fluoromethyl group. The method involves a sequence of reactions that can be summarized:

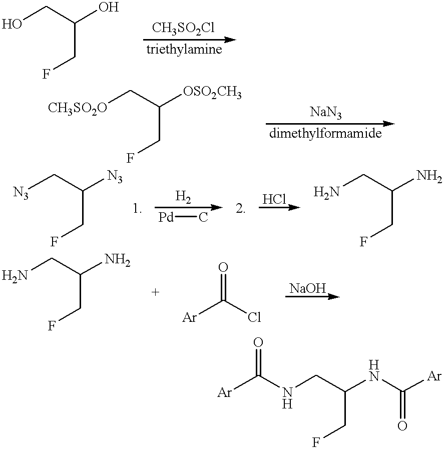

where Ar represents a suitable aryl group.

In a first step of Method I as illustrated here, (3-fluoro-1,2-propanedylbis) methanesulfonate is prepared as a first intermediate. Triethylamine (5.9 ml, 42.4 mmol) is added to a solution of 3-fluoro-1,2-propanediol (1.65 g, 17.6 mmol) in 35 ml methylene chloride. The mixture is cooled to −10° C. in an ice/acetone bath and methanesulfonyl chloride (3 ml, 38.8 mmol) is added dropwise. The resulting reaction mixture is stirred at 0° C. for 1 h and then poured on to 150 ml ice/water. The phases are separated and the aqueous phase extracted once with methylene chloride. The combined organic layers are successively washed with 1N hydrochloric acid solution, saturated sodium bicarbonate solution and brine, then dried over Na₂SO₄ and concentrated to give 2.53 g (3-fluoro-1,2-propanediylbis)methanesulfonate as an amber oil: ¹H NMR (CDCl₃) δ 3.08 (s, 3H), 3.12 (s, 3H), 4.38-4.51 (m, 2H), 4.56-4.75 (m, 2H), 5.04 (m, 1H).

In a second step of Method I as illustrated here, 1,2-diazido-3-fluoropropane is prepared as a second intermediate. Sodium azide (1.97 g, 30.3 mmol) is added to a solution of (3-fluoro-1,2-propanediylbis)methanesulfonate (2.53 g, 10.1 mmol) prepared as above, in 20 ml dimethylformamide and the mixture is heated under nitrogen at 80° C. for 16 h. After cooling to room temperature, the reaction mixture is partitioned between diethyl ether and 10% aqueous sodium chloride solution. The phases are separated and the aqueous phase separated once with ether. The combined ether solutions are washed successively with 0.5N hydrochloric acid solution, saturated sodium bicarbonate solution and brine, dried over Na₂SO₄ and concentrated to provide 1.2 g 1,2-diazido-3-fluoropropane as an amber liquid: ¹H NMR (CDCl₃) δ 3.47 (m, 2H), 3.77 (m, 1H), 4.44 (m, 1H), 4.60 (m, 1H).

In a third step of Method I as illustrated here, 1,2-diamino-3-fluoropropane dihydrochloride is prepared as a third intermediate. A Parr hydrogenation bottle is purged with nitrogen and charged with 0.15 g 10% palladium on carbon catalyst and 45 ml absolute ethanol. To this is added 1.0 g (6.9 mmol) 1,2-diazido-3-fluoropropane prepared as above, and the bottle is charged with hydrogen. After shaking for 2 h at room temperature, the catalyst is removed by filtration through celite and the filtrate is saturated with gaseous HCl while cooling in an ice bath. The resulting white precipitate is collected by filtration and dried under vacuum to provide 0.8 g 1,2-diamino-3-fluoropropane dihydrochloride: ¹H NMR (D₂O) δ 3.28 (m, 2H), 3.80 (m, 1H), 4.5-4.8 (m, 2H).

In a fourth step of Method I as illustrated here, N,N′-(3-fluoro-1,2-propanediylbis)-3-(trifluoromethyl)benzamide is prepared from the third intermediate. To a solution of 0.05 g (0.303 mmol) 1,2-diamino-3-fluoropropane dihydrochloride prepared as above, in 1 ml 2.5N sodium hydroxide solution, is added 0.1 ml (0.692 mmol) 3-trifluoromethylbenzoyl chloride in one portion, and the mixture is stirred vigorously for 2 h. The rsulting solid is collected by filtration, washed with water and dried under vacuum to provide 0.105 g N,N′-(3-fluoro-1,2-propanediylbis)-3-(trifluoromethyl)benzamide: ¹H NMR(CDCl₃) δ 3.69 (m, 1H), 3.98 (m, 1H), 4.44-4.76 (3H), 7.55 (dt, 2H), 7.7.74 (dd, 2H), 7.94 (dd, 2H), 8.06 (d, 2H).

Method J

This method is illustrated by preparation of R—N-[1-methyl-2-(3-trifluoromethyl)phenylcarbonylamino]ethyl-3-(trifluoromethyl)phenylcarbamate, which is the compound of Example 229 herein. Method J is generally applicable to preparation of asymmetrical diacyl compounds of formulas (I) or (II) wherein R⁴ or R⁶ is an aryloxy group. The method involves a reaction that can be summarized:

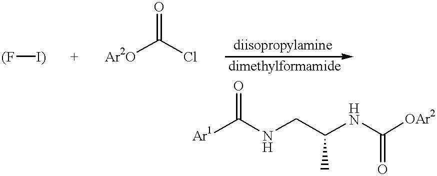

where Ar¹ and Ar¹ represent suitable aryl groups.

To a solution of 0.126 g (0.512 mmol) R—N-(2-amino-1-propyl)-3-(trifluoromethyl)benzamide prepared as an intermediate exactly as in Method F above, and 0.066 g (0.512 mmol) N,N-diisopropylethylamine in 4 ml dimethylformamide and 3 ml acetonitrile, is slowly added 0.115 g (0.512 mmol) 3-(trifluoromethyl)phenyl chloroformate in 2 ml methylene chloride. The resulting solution is stirred for 2 h, then evaporated to dryness. Purification of the resulting crude product by flash chromatography on silica gel using 2:1 hexane-ethyl acetate mixture provides 74.2 mg (33% yield) R—N-[1-methyl-2-(3-trifluoromethyl)phenylcarbonylamino]ethyl-3-(trifluoromethyl)phenylcarbamate as a white powder: ¹H NMR (CDCl₃) δ 1.33 (3H, d), 3.53 (1H, dt), 3.68 (1H, m), 4.05 (1H, m), 5.6 (1H, d), 7.07 (1H, br), 7.20 (1H, d), 7.26 (1H, d), 7.43 (2H, m), 7.53 (1H, t), 7.75 (1H, d), 7.93 (1H, d), 8.08 (1H, s).

Illustrative Examples of Compounds of Formula (III)

The compounds of Examples 1 to 280 tabulated below in Tables 1-14 are illustrative of those contemplated to have activity in killing, controlling growth of and/or eliciting symptoms of phytotoxicity in plants when applied directly to the plants or to the medium in which they are growing. For each Example, one method is indicated by which the compound of that Example has been prepared; however, it is to be understood that many compounds listed in Tables 1-14 can be prepared by more than one method. The following conventional abbreviations are used in Tables 1-14: Me=methyl; Et=ethyl; Pr=propyl; iPr=isopropyl; cPr=cyclopropyl; Bu=butyl; iBu =isobutyl; tBu=tert-butyl; Ph=phenyl; Pz3=pyrazol-3-yl.

TABLE 1

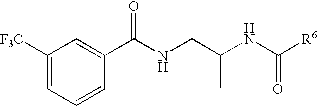

| Example | Method | R⁶ |
|---|---|---|
| 1 | E | CHCl₂ |
| 2 | E | α-Cl—Et |
| 3 | C | α-Cl—Pr |
| 4 | E | α-Cl-cPr |

TABLE 2

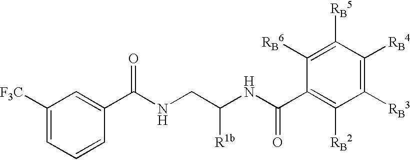

| Example | Method | R^{1b} | R_{B}² | R_{B}³ | R_{B}⁴ | R_{B}⁵ | R_{B}⁶ |
|---|---|---|---|---|---|---|---|
| 5 | A | Me | H | CF₃ | H | H | H |
| 5a | B | Me* | H | CF₃ | H | H | H |
| 5b | B | Me** | H | CF₃ | H | H | H |
| 6 | C | Me | H | CF₃ | F | H | H |
| 7 | C | Me | H | CF₃ | H | F | H |
| 8 | C | Me | H | CF₃ | H | H | F |
| 9 | C | Me | H | CF₃ | H | H | Cl |
| 10 | I | CH₂F | H | CF₃ | H | H | H |
| 11 | H | CH₂OH | H | CF₃ | H | H | H |
| 12 | H | CH₂Cl | H | CF₃ | H | H | H |
| 13 | F | Me* | F | CF₃ | H | H | H |
| 14 | C | Me | Cl | CF₃ | H | H | H |
| 15 | F | Me* | I | CF₃ | H | H | H |
| 16 | F | Me* | Me | CF₃ | H | H | H |
| 17 | G | Me* | OMe | CF₃ | H | H | H |
| 18 | G | Me | OiPr | CF₃ | H | H | H |
| 19 | G | Me* | OCH₂C≡CH | CF₃ | H | H | H |
| 20 | G | Me* | OCH₂Ph | CF₃ | H | H | H |
| 21 | C | Me | H | CHCl₂ | H | H | H |
| 22 | E | Me | H | CH₂Cl | H | H | H |
| 23 | E | Me | H | F | H | H | H |
| 24 | C | Me | H | F | CF₃ | H | H |
| 25 | E | Me | H | F | F | H | H |
| 26 | C | Me | H | F | F | F | H |
| 27 | C | Me | H | F | F | H | F |
| 28 | C | Me | H | F | F | H | Cl |
| 29 | C | Me | H | F | Cl | H | F |
| 30 | C | Me | H | F | Cl | H | Cl |
| 31 | E | Me | H | F | H | F | H |
| 32 | C | Me | H | F | H | H | CF₃ |
| 33 | E | Me | H | F | H | H | F |
| 34 | E | Me | F | F | H | H | H |
| 34a | F | Me* | F | F | H | H | H |
| 35 | E | Me | F | F | F | H | H |
| 36 | D | Me | F | F | F | F | H |
| 37 | F | Me* | Cl | F | H | H | H |
| 38 | C | Me | Me | F | H | H | H |
| 39 | D | Me | Et | F | H | H | H |
| 40 | G | Me* | OMe | F | H | H | H |
| 41 | F | Me* | OEt | F | H | H | H |
| 42 | G | Me* | OiPr | F | H | H | H |
| 43 | E | Me | H | Cl | H | H | H |
| 44 | E | Me | H | Cl | Cl | H | H |
| 45 | C | Me | H | Cl | H | H | Cl |
| 46 | C | Me | H | Cl | H | H | Br |
| 47 | C | Me | H | Cl | H | H | Me |
| 48 | C | Me | H | Cl | H | H | OMe |
| 49 | C | Me | F | Cl | H | H | H |
| 50 | C | Me | Cl | Cl | H | H | H |
| 51 | C | Me | Me | Cl | H | H | H |
| 52 | C | Me | H | Br | H | H | H |
| 53 | C | Me | H | Br | Cl | H | H |
| 54 | C | Me | H | Br | H | H | Cl |
| 55 | C | Me | H | Br | H | H | Br |
| 56 | F | Me* | F | Br | H | H | H |
| 57 | F | Me* | Me | Br | H | H | H |
| 58 | F | Me* | OMe | Br | H | H | H |
| 59 | C | Me | H | I | H | H | H |
| 60 | C | Me | H | I | H | H | F |
| 61 | F | Me* | Me | I | H | H | H |
| 62 | E | Me | H | Me | H | H | H |
| 63 | C | Me | H | Me | H | H | Cl |
| 64 | C | Me | H | Me | H | H | Me |
| 65 | F | Me* | Cl | Me | H | H | H |
| 66 | F | Me* | Br | Me | H | H | H |
| 67 | F | Me* | Me | Me | H | H | H |
| 68 | F | Me* | OMe | Me | H | H | H |
| 69 | C | Me | OPh | Me | H | H | H |
| 70 | D | Me | H | Ph | H | H | OMe |
| 71 | D | Me | OMe | Ph | H | H | H |
| 72 | E | Me | H | OCF₃ | H | H | H |
| 73 | C | Me | H | SCF₃ | H | H | H |
| 74 | C | Me | H | OCF₂H | H | H | H |
| 75 | E | Me | H | OMe | H | H | H |
| 76 | D | Me | H | OMe | Cl | H | F |
| 77 | C | Me | H | OMe | H | H | Br |
| 78 | C | Me | H | SMe | H | H | Cl |
| 79 | C | Me | H | OCF₂CF₂H | H | H | H |
| 80 | D | Me | H | OiPr | H | H | H |
| 81 | D | Me | H | OiBu | H | H | H |
| 82 | C | Me | H | OPh | H | H | H |
| 83*** | D | Me | H | O(1Me,4Cl,5CF₃)Pz3 | H | H | H |
| 84 | E | Me | H | CN | H | H | H |
| 85 | E | Me | H | NO₂ | H | H | H |
| 86 | C | Me | H | NO₂ | F | H | H |
| 87 | E | Me | H | NO₂ | Cl | H | H |
| 88 | C | Me | H | NO₂ | H | H | F |
| 89 | C | Me | H | NO₂ | H | H | Cl |
| 90 | C | Me | H | NO₂ | H | H | Br |
| 91 | C | Me | H | NO₂ | H | H | I |
| 92 | C | Me | H | NO₂ | H | H | Me |
| 93 | C | Me | Cl | NO₂ | H | H | H |
| 94 | C | Me | Br | NO₂ | H | H | H |
| 95 | C | Me | Me | NO₂ | H | H | H |
| 96 | E | Me | CF₃ | H | H | H | H |
| 97 | C | Me | CF₃ | H | F | H | H |
| 98 | E | Me | F | H | H | H | H |
| 99 | See | | | | | | |
| | Table | | | | | | |
| | 3 | | | | | | |
| 100 | C | Me | F | H | CF₃ | H | H |
| 101 | E | Me | F | H | F | H | H |
| 102 | C | Me | F | H | Cl | H | H |
| 103 | E | Me | Cl | H | H | H | H |
| 104 | E | Me | Cl | H | Cl | H | H |
| 105 | E | Me | Br | H | H | H | H |
| 106 | C | Me | Br | H | F | H | H |
| 107 | C | Me | I | H | H | H | H |
| 108 | C | Me | I | H | Cl | H | H |
| 109 | E | Me | Me | H | H | H | H |
| 110 | C | Me | Me | H | Cl | H | H |
| 111 | C | Me | CH₂Ph | H | H | H | H |
| 112 | C | Me | CH₂CH₂Ph | H | H | H | H |
| 113 | C | Me | OCF₃ | H | H | H | H |
| 114 | E | Me | OMe | H | H | H | H |
| 115 | C | Me | SMe | H | H | H | H |
| 116 | D | Me | SCH₂CF₃ | H | H | H | H |
| 117 | C | Me | OEt | H | H | H | H |
| 118 | D | Me | OPr | H | H | H | H |
| 119 | D | Me | SCH₂CH₂CH₂Cl | H | H | H | H |
| 120 | D | Me | SCH₂C≡CH | H | H | H | H |
| 121 | D | Me | OCH₂CH═CH₂ | H | H | H | H |
| 122 | D | Me | SCH₂CCl═CH₂ | H | H | H | H |
| 123 | D | Me | SCH₂CCl═CHCl | H | H | H | H |
| 124 | D | Me | SCH₂C(Me)═CH₂ | H | H | H | H |
| 125 | D | Me | SCH₂CH═CHMe₂ | H | H | H | H |
| 126 | D | Me | O(2Cl)Ph | H | H | H | H |
| 127 | D | Me | O(4Cl)Ph | H | H | H | H |
| 128 | D | Me | S(4F)Ph | H | H | H | H |
| 129 | C | Me | OCH₂Ph | H | H | H | H |
| 130 | D | Me | OCH₂(3Me)Ph | H | H | H | H |
| 131 | D | Me | SCH₂(4F)Ph | H | H | H | H |
| 132 | E | Me | H | H | CF₃ | H | H |
| 133 | E | Me | H | H | F | H | H |
| 134 | E | Me | H | H | Cl | H | H |
| 135 | C | Me | H | H | CH₂Cl | H | H |

| | | | | | | |
|---|---|---|---|---|---|---|
| 136 | C | Me | —OCH₂CH₂— | H | H | H |
| 137 | E | Me | —CH═CHCH═CH— | H | H | H |
| 138 | D | Me | —CH═CHCH═CBr— | H | H | H |
| 139 | D | Me | —SC(OEt)═N— | H | H | H |

*at R^{1b} denotes R-isomer
**at R^{1b} denotes S-isomer
***R_{B}³ substitutent in this Example is:

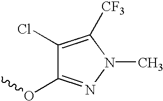

TABLE 3

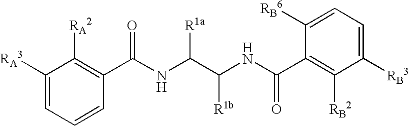

| Example | Method | R^{1a} | R^{1b} | R_{A}² | R_{A}³ | R_{B}² | R_{B}³ | R_{B}⁶ |
|---|---|---|---|---|---|---|---|---|
| 99 | E | Me | H | H | CF₃ | F | H | H |
| 140 | B | H | Me* | F | CF₃ | F | CF₃ | H |
| 141 | F | Me* | H | F | CF₃ | Cl | CF₃ | H |
| 142 | F | Me* | H | F | CF₃ | H | F | H |
| 143 | F | Me* | H | F | CF₃ | H | F | F |
| 144 | F | Me* | H | F | CF₃ | Me | F | H |
| 145 | F | Me* | H | F | CF₃ | H | Cl | H |
| 146 | F | Me* | H | F | CF₃ | H | Cl | Cl |
| 147 | F | Me* | H | F | CF₃ | H | Cl | Me |
| 148 | F | H | Me* | F | CF₃ | Cl | Cl | H |
| 149 | F | Me* | H | F | CF₃ | Cl | Cl | H |
| 150 | F | H | Me* | F | CF₃ | Me | Cl | H |
| 151 | F | Me* | H | F | CF₃ | Me | Cl | H |
| 152 | F | Me* | H | F | CF₃ | H | Br | H |
| 153 | F | Me* | H | F | CF₃ | H | Br | Cl |
| 154 | F | Me* | H | F | CF₃ | H | Br | Br |
| 155 | F | Me* | H | F | CF₃ | H | I | H |
| 156 | F | Me* | H | F | CF₃ | Me | I | H |
| 157 | F | Me* | H | F | CF₃ | H | Me | H |
| 158 | F | Me* | H | F | CF₃ | H | Me | Cl |
| 159 | F | Me* | H | F | CF₃ | H | Me | Me |
| 160 | F | H | Me* | F | CF₃ | Cl | Me | H |
| 161 | F | Me* | H | F | CF₃ | Cl | Me | H |
| 162 | F | Me* | H | F | CF₃ | Br | Me | H |
| 163 | F | Me* | H | F | CF₃ | Me | Me | H |
| 164 | F | Me* | H | F | CF₃ | CF₃ | H | H |
| 165 | F | Me* | H | F | CF₃ | F | H | H |
| 166 | F | Me* | H | F | CF₃ | Cl | H | H |
| 167 | F | Me* | H | F | CF₃ | I | H | H |
| 168 | F | Me* | H | F | CF₃ | —CH═CHCH═CH— | | H |
| 169 | F | H | Me* | Cl | CF₃ | Cl | Cl | H |
| 170 | F | H | Me* | Cl | CF₃ | Me | Cl | H |
| 171 | F | H | Me* | Cl | CF₃ | Cl | Me | H |
| 172 | F | H | Me* | H | F | Cl | Cl | H |
| 173 | F | H | Me* | H | F | Me | Cl | H |
| 174 | F | H | Me* | H | F | Cl | Me | H |
| 175 | F | H | Me* | Me | F | Cl | Cl | H |
| 176 | F | H | Me* | Me | F | Me | Cl | H |
| 177 | F | H | Me* | Me | F | Cl | Me | H |
| 178 | F | H | Me* | H | Cl | Cl | Cl | H |
| 179 | F | H | Me* | H | Cl | Me | Cl | H |
| 180 | F | H | Me* | H | Cl | Cl | Me | H |
| 181 | B | H | Me* | F | Cl | F | Cl | H |
| 182 | F | Me* | H | Cl | Cl | H | F | F |
| 183 | B | H | Me* | Cl | Cl | Cl | Cl | H |
| 184 | F | H | Me* | Cl | Cl | Me | Cl | H |
| 185 | F | Me* | H | Cl | Cl | H | Cl | Cl |
| 186 | F | Me* | H | Cl | Cl | H | Cl | Me |
| 187 | F | Me* | H | Cl | Cl | H | Br | Cl |
| 188 | F | Me* | H | Cl | Cl | H | Br | Br |
| 189 | F | Me* | H | Cl | Cl | H | Me | H |
| 190 | F | H | Me* | Cl | Cl | Cl | Me | H |
| 191 | F | Me* | H | Cl | Cl | Cl | Me | H |
| 192 | F | Me* | H | Cl | Cl | Br | Me | H |
| 193 | F | Me* | H | Cl | Cl | Me | Me | H |
| 194 | F | Me* | H | Cl | Cl | H | Me | Cl |
| 195 | F | Me* | H | Cl | Cl | H | Me | Me |
| 196 | F | Me* | H | Cl | Cl | CF₃ | H | H |
| 197 | F | Me* | H | Cl | Cl | F | H | H |
| 198 | F | Me* | H | Cl | Cl | Cl | H | H |
| 199 | F | Me* | H | Cl | Cl | I | H | H |
| 200 | F | Me* | H | Cl | Cl | —CH═CHCH═CH— | | H |
| 201 | F | Me* | H | Me | Cl | H | F | F |
| 202 | F | H | Me* | Me | Cl | Cl | Cl | H |
| 203 | B | H | Me* | Me | Cl | Me | Cl | H |
| 204 | F | Me* | H | Me | Cl | H | Cl | Cl |
| 205 | F | Me* | H | Me | Cl | H | Cl | Me |
| 206 | F | Me* | H | Me | Cl | H | Br | Cl |
| 207 | F | Me* | H | Me | Cl | H | Br | Br |
| 208 | F | Me* | H | Me | Cl | H | Me | H |
| 209 | F | Me* | H | Me | Cl | H | Me | Me |
| 210 | F | H | Me* | Me | Cl | Cl | Me | H |
| 211 | F | Me* | H | Me | Cl | Cl | Me | H |
| 212 | F | Me* | H | Me | Cl | Br | Me | H |
| 213 | F | Me* | H | Me | Cl | CF₃ | H | H |
| 214 | F | Me* | H | Me | Cl | F | H | H |
| 215 | F | Me* | H | Me | Cl | Cl | H | H |
| 216 | F | Me* | H | Me | Cl | —CH═CHCH═CH— | | H |
| 217 | F | H | Me* | H | Br | Cl | Cl | H |
| 218 | F | H | Me* | H | Br | Me | Cl | H |
| 219 | F | H | Me* | H | Br | Cl | Me | H |
| 220 | F | H | Me* | H | I | Cl | Cl | H |
| 221 | F | H | Me* | H | I | Me | Cl | H |
| 222 | F | H | Me* | H | I | Cl | Me | H |
| 223 | F | H | Me* | Me | I | Cl | Cl | H |
| 224 | F | H | Me* | Me | I | Me | Cl | H |
| 225 | F | H | Me* | Me | I | Cl | Me | H |

* at R^{1b} denotes R-isomer

TABLE 4

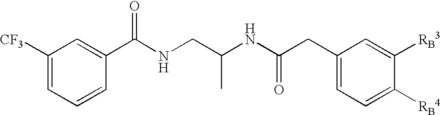

| Example | Method | R_{B}³ | R_{B}⁴ |
|---|---|---|---|
| 226 | E | OMe | H |
| 227 | E | H | H |
| 228 | E | H | OMe |

TABLE 5

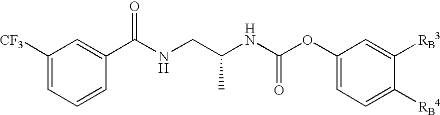

| Example | Method | R_{B}³ | R_{B}⁴ |
|---|---|---|---|
| 229 | J | CF₃ | H |
| 230 | J | H | F |
| 231 | J | H | Cl |

TABLE 6

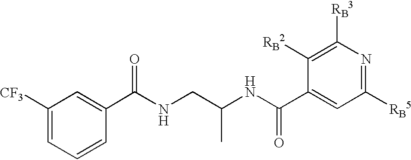

| Example | Method | R_{B}² | R_{B}³ | R_{B}⁵ |
|---|---|---|---|---|
| 232 | E | H | Cl | H |
| 233 | E | H | Cl | Cl |
| 234 | E | H | Me | Cl |

| | | | |
|---|---|---|---|
| 235 | C | —CH═CHCH═CH— | H |

TABLE 7

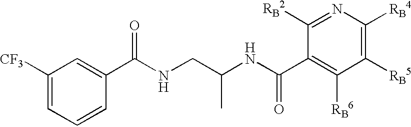

| | | | | | |
|---|---|---|---|---|---|
| Example | Method | R_{B}² | R_{B}⁴ | R_{B}⁵ | R_{B}⁶ |

| | | | | | |
|---|---|---|---|---|---|
| 236 | E | Cl | H | H | H |
| 237 | E | Cl | H | Cl | H |
| 238 | C | Cl | Cl | H | H |
| 239 | C | Me | H | H | H |
| 240 | C | OMe | H | H | H |
| 241 | E | SMe | H | H | H |
| 242 | C | OH | H | H | H |
| 243 | E | SEt | H | H | H |
| 244 | C | SBu | H | H | H |
| 245 | C | SCH₂CH═CH₂ | H | H | H |
| 246 | C | SPh | H | H | H |
| 247 | E | O(4Cl)Ph | H | H | H |
| 248 | E | S(4Cl)Ph | H | H | H |
| 249 | E | O(4Me)Ph | H | H | H |
| 250 | E | S(4Me)Ph | H | H | H |
| 251*** | D | O(1Me,5CF₃)Pz3 | H H | H | |
| 252 | C | H | H | H | CF₃ |
| 253 | E | H | Cl | H | H |
| 254 | C | H | Cl | Cl | H |
| 255 | C | H | Cl | H | Cl |
| 256 | E | H | H | Br | H |

***R_{B}² substituent in this Example is:

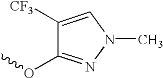

TABLE 8

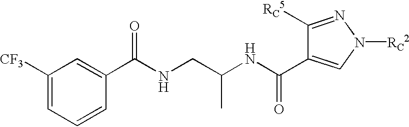

| Example | Method | R_{C}² | R_{C}⁵ |
|---|---|---|---|
| 257 | E | Me | CF₃ |
| 258 | E | Me | CF₂H |
| 259 | E | Me | CF₂Cl |

TABLE 9

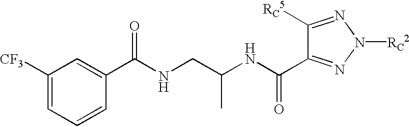

| Example | Method | R_{C}² | R_{C}³ |
|---|---|---|---|
| 260 | E | Ph | Me |

TABLE 10

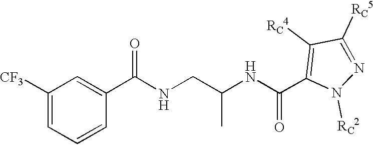

| Example | Method | R_{C}² | R_{C}⁴ | R_{C}⁵ |
|---|---|---|---|---|
| 261 | E | Me | Cl | CF₃ |
| 262 | E | Me | H | tBu |
| 263 | E | Ph | H | Me |

TABLE 11

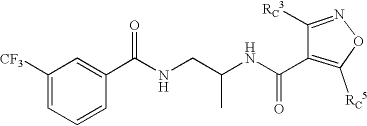

| Example | Method | R_{C}³ | R_{C}⁵ |
|---|---|---|---|
| 264 | D | (2Cl,4F)Ph | CF₂Cl |

TABLE 12

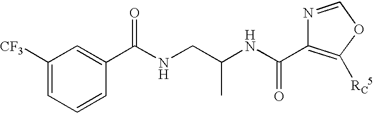

| Example | Method | R_{C}³ |
|---|---|---|
| 265 | C | Ph |
| 266 | C | (3CF₃)Ph |
| 267 | C | (3Cl)Ph |

TABLE 13

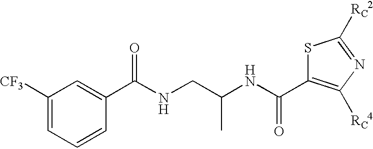

| Example | Method | R_{C}² | R_{C}⁴ |
|---|---|---|---|
| 268 | D | CF₃ | Br |
| 269 | D | Cl | CF₃ |
| 270 | D | Cl | Cl |
| 271 | D | Me | CF₃ |
| 272 | D | Me | CF₂H |
| 273 | D | Me | Me |
| 274 | D | iPr | CF₃ |
| 275 | D | iPr | Me |
| 276 | D | Ph | CF₃ |
| 277 | D | Ph | Me |
| 278 | D | OMe | CF₃ |
| 279 | D | OPh | H |

TABLE 14

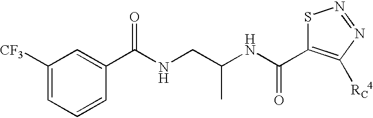

| Example | Method | R_{C}⁴ |
|---|---|---|
| 280 | D | Me |

Pre-emergence Herbicidal Activity of Compounds of Formula (II)

As noted above, compounds of this invention have been found to be useful for killing, controlling growth of and/or eliciting symptoms of phytotoxicity in plants. All such uses, and the biological activity enabling such uses, are embraced by the term “herbicidal” herein. Tables 15 and 16 summarize results of tests conducted as described below to determine the pre-emergence herbicidal activity, in the form of a GR₈₀ value, of illustrative compounds of this invention. The GR₈₀ value as used herein is not a true GR₈₀, instead being defined as the lowest tested rate (in g/ha) at which 80% or greater inhibition was observed in the test in question. Where herbicidal activity was evident but 80% inhibition was not achieved at the highest rate tested (typically 1000 g/ha), an asterisk (*) is shown in the following tables. Herbicidal activity evident in the form of symptoms of phytotoxicity, in the absence of at least 80% inhibition at any rate, is indicated in the tables by “phyto”. A blank cell in the following tables indicates no herbicidal or phytotoxic response at any rate tested.

The pre-emergence tests were conducted by the following procedure. Topsoil was sieved to pass through a 1.27 cm screen. Fertilizer was added to the topsoil and the mixture was then sterilized by heating. The topsoil mixture was placed in a pot and compacted to a depth of 1.0 to 1.25 cm from the top of the pot. Seeds of each of several monocotyledonous and dicotyledonous annual plant species were placed on top of the soil. Additional soil was subsequently placed over the seeds to level-fill the pot. A known amount of each test compound dissolved or suspended in an appropriate organic solvent was diluted with a 50:50 mix of acetone and water and applied to the surface of the soil. After treatment the plants were placed in a greenhouse with a 30/21° C. day/night temperature regime where they received 0.64 cm of overhead irrigation. All subsequent watering consisted of a light overhead mist and/or subirrigation as needed for germination and growth.

Approximately 14 days after planting and treating, the plants were observed and herbicidal efficacy recorded as percent inhibition by comparison with untreated plants.

The plant species usually regarded as weeds which were utilized in the tests are identified in the tables below according to the following legend, in which “d” indicates a dicotyledonous species and “m” a monocotyledonous species. All monocotyledonous species included in the tests herein are grasses.

| | | | |
|---|---|---|---|
| ABUTH | velvetleaf | Abutilon theophrasti | d |
| AMARE | redroot pigweed | Amaranthus retroflexus | d |
| BRAPP | broadleaf signalgrass | Brachiaria platyphylla | m |
| CHEAL | common lambsquarters | Chenopodium album | d |
| CIRAR | canada thistle (seedling) | Cirsium arvense | d |
| CONAR | field bindweed | Convolvulus arvensis | d |
| DATST | jimsonweed | Datura stramonium | d |
| DIGSA | large crabgrass | Digitaria sanguinalis | m |
| ECHCG | barnyardgrass | Echinochloa crus-galli | m |
| PANDI | fall panicum | Panicum dichotomiflorum | m |
| PANMI | wild proso millet | Panicum miliaceum | m |
| POROL | common purslane | Portulaca oleracea | d |
| SETFA | giant foxtail | Setaria faberi | m |
| SOLNI | black nightshade | Solanum nigrum | d |
| SORHA | johnsongrass (seedling) | Sorghum halepense | m |
| SORVU | shattercane | Sorghum vulgare | m |

TABLE 15
Pre-emergence activity (GR₈₀, g/ha) on dicotyledonous species

| Example | ABUTH | SOLNI | AMARE | DATST | CHEAL | CONAR | PORAL | CIRAR |
|---|---|---|---|---|---|---|---|---|
| 4 | | | | | | | | |
| 5 | 1000 | 750 | 125 | 500 | 250 | phyto | 250 | 250 |
| 6 | | | 1000 | | | | | |
| 9 | phyto | 500 | 125 | 500 | 500 | | 125 | 750 |
| 10 | | | 500 | phyto | 750 | | 1000 | phyto |
| 11 | | | | | | | | |
| 12 | | | | | | | | |
| 13 | 250 | 125 | 64 | 125 | 64 | 750 | 64 | 64 |
| 14 | 250 | 125 | 125 | 64 | 64 | 125 | 125 | 64 |
| 15 | | * | 64 | * | 125 | phyto | 500 | phyto |
| 16 | * | 500 | 250 | 1000 | 1000 | | | 750 |
| 17 | | phyto | 1000 | phyto | 1000 | | 1000 | |
| 19 | | | | | | | | |
| 20 | | | 1000 | | phyto | | | phyto |
| 34 | 500 | 250 | 125 | 250 | 125 | 750 | 125 | 125 |
| 37 | 250 | 250 | 64 | 250 | 125 | 250 | 64 | 250 |
| 38 | 125 | 250 | 32 | 125 | 64 | 250 | 32 | 125 |
| 40 | phyto | phyto | 750 | 1000 | 750 | phyto | * | no data |
| 41 | | phyto | 250 | 1000 | 750 | | 500 | |
| 42 | | | | | | | | |
| 43 | | phyto | 250 | phyto | 500 | | 500 | * |
| 47 | 250 | 125 | 64 | 250 | 64 | 750 | 125 | 125 |
| 49 | 64 | 125 | 64 | 64 | 64 | 750 | 64 | 64 |
| 50 | 750 | 125 | 32 | 125 | 32 | 250 | 32 | 64 |
| 51 | 250 | 125 | 125 | 250 | 64 | 1000 | 64 | 125 |
| 56 | 500 | 64 | 64 | 250 | 32 | * | 32 | 32 |
| 57 | 750 | 250 | 64 | 125 | 32 | 250 | 125 | 500 |
| 59 | phyto | phyto | 250 | 1000 | 500 | phyto | 125 | 1000 |
| 61 | * | 250 | 750 | 1000 | 1000 | | 500 | 250 |
| 64 | 500 | 250 | 250 | 1000 | 250 | | 250 | 250 |
| 65 | 250 | 500 | 125 | 250 | 32 | 250 | 125 | 125 |
| 66 | 250 | 750 | 250 | 500 | 125 | 250 | 500 | 500 |
| 67 | 500 | | 500 | 500 | 250 | 1000 | 500 | 500 |
| 68 | | | | | | | | |
| 72 | 1000 | | 125 | 1000 | 500 | * | 250 | 500 |
| 73 | phyto | 1000 | 250 | phyto | 750 | phyto | 750 | phyto |
| 76 | | | | | | | | |
| 83 | | | | | | | | |
| 103 | 750 | 250 | 125 | 500 | 500 | * | 125 | 750 |
| 109 | phyto | 750 | 250 | 500 | 750 | phyto | 750 | 750 |
| 119 | phyto | 1000 | | | | | | |
| 124 | | phyto | | | | | | 1000 |
| 131 | | | | | | | | |
| 139 | | 1000 | 500 | 1000 | 750 | | 500 | |
| 142 | 1000 | 750 | 125 | 750 | 500 | | 125 | 64 |
| 145 | 500 | 1000 | 125 | | 125 | | 125 | 125 |
| 150 | 1000 | 64 | 32 | 32 | 32 | 125 | 32 | 125 |
| 152 | 750 | 500 | 250 | 750 | 250 | | 125 | 250 |
| 181 | phyto | * | 500 | * | 750 | phyto | | * |
| 203 | phyto | phyto | | phyto | 1000 | | | phyto |
| 229 | * | 1000 | 300 | phyto | 300 | phyto | 100 | 300 |
| 230 | | * | 500 | 750 | 1000 | phyto | 500 | 750 |
| 231 | | phyto | 750 | phyto | phyto | | phyto | phyto |
| 243 | 500 | 250 | 750 | 250 | 250 | 250 | 250 | 250 |
| 244 | * | 750 | 750 | phyto | | | 750 | |
| 247 | phyto | 1000 | 1000 | 1000 | 100 | phyto | 300 | phyto |
| 250 | phyto | | | * | phyto | phyto | | phyto |
| 257 | | | | | | | | |
| 262 | | | | | | phyto | | |
| 264 | | 250 | 250 | 1000 | 500 | | 500 | |

TABLE 16
Pre-emergence activity (GR₈₀, g/ha) on monocotyledonous species

| Example | ECHCG | PANMI | SORHA | SETFA | PANDI | SORVU | BRAPP | DIGSA |
|---|---|---|---|---|---|---|---|---|
| 4 | | | | | | | | |
| 5 | phyto | phyto | phyto | * | 500 | phyto | * | 250 |
| 6 | | phyto | | phyto | phyto | | | phyto |
| 9 | phyto | phyto | * | 1000 | 500 | | phyto | 500 |
| 10 | | phyto | | phyto | 1000 | | | phyto |
| 11 | | | | | | | | |
| 12 | | | | | | | | |
| 13 | 500 | 500 | 500 | 125 | 250 | 1000 | 500 | 125 |
| 14 | 1000 | 500 | 500 | 250 | 250 | phyto | 500 | 125 |
| 15 | phyto | | | phyto | phyto | | | phyto |
| 16 | | 1000 | | 500 | * | | | 750 |
| 17 | | | | phyto | phyto | | | 1000 |
| 19 | | | | | | | | |
| 20 | | phyto | | | phyto | | | phyto |
| 34 | 1000 | 250 | 750 | 250 | 125 | phyto | 250 | 125 |
| 37 | 1000 | 500 | 1000 | 250 | 250 | | 500 | 250 |
| 38 | 1000 | 250 | 500 | 250 | 250 | * | 250 | 125 |
| 40 | phyto | phyto | phyto | 1000 | 750 | phyto | * | no data |
| 41 | | phyto | phyto | 1000 | 750 | | | no data |
| 42 | | | | | | | | |
| 43 | | phyto | phyto | phyto | phyto | | phyto | 750 |
| 47 | phyto | 250 | 750 | 250 | 250 | phyto | 500 | 125 |
| 49 | 500 | 125 | 250 | 125 | 64 | * | 500 | 64 |
| 50 | * | 1000 | 1000 | 750 | 250 | * | 500 | 125 |
| 51 | * | 250 | 1000 | 250 | 250 | phyto | 500 | 64 |
| 56 | 750 | 125 | 750 | 125 | 250 | | 500 | 64 |
| 57 | * | 750 | * | 250 | 125 | | 750 | 500 |
| 59 | phyto | | phyto | 1000 | phyto | | phyto | phyto |
| 61 | | | | 1000 | 750 | | | 1000 |
| 64 | 1000 | 500 | * | 1000 | 250 | | 500 | 250 |
| 65 | 500 | 750 | * | 250 | 125 | | 500 | 250 |
| 66 | 750 | 750 | * | 500 | 500 | | 1000 | 750 |
| 67 | * | | | 750 | 500 | | 1000 | 500 |
| 68 | | | | | phyto | | | phyto |
| 72 | phyto | phyto | * | 500 | 500 | phyto | 1000 | 250 |
| 73 | phyto | phyto | phyto | phyto | * | | phyto | phyto |
| 76 | | | | | | | | |
| 83 | | | | | | | | |
| 103 | phyto | 1000 | 500 | 500 | 500 | phyto | 750 | 500 |
| 109 | phyto | 1000 | * | 750 | 750 | | * | 250 |
| 119 | | | phyto | phyto | | | phyto | |
| 124 | phyto | phyto | | phyto | | | phyto | 1000 |
| 131 | | | | | | | | |
| 139 | | 1000 | | | 1000 | | phyto | phyto |
| 142 | | 1000 | | 125 | 500 | | 750 | 250 |
| 145 | | | | 750 | 500 | | | 250 |
| 150 | * | 64 | * | 125 | 125 | phyto | * | 32 |
| 152 | 750 | | | | | | | 500 |
| 181 | | | | phyto | phyto | | | 500 |
| 203 | | | | | | | | |
| 229 | phyto | phyto | phyto | phyto | 300 | | | 1000 |
| 230 | phyto | phyto | phyto | * | 1000 | | phyto | 750 |
| 231 | | | | phyto | phyto | | phyto | 1000 |
| 243 | 1000 | 750 | * | 500 | 500 | phyto | 500 | 500 |
| 244 | phyto | phyto | | | | | phyto | phyto |
| 247 | phyto | 1000 | 1000 | 1000 | 300 | phyto | phyto | 300 |
| 250 | phyto | phyto | | phyto | phyto | | | 750 |
| 257 | | | | | | | | |
| 262 | | | | | | | | phyto |
| 264 | | | | | 1000 | | | |

Post-emergence Herbicidal Activity of Compounds of Formula (II)

In another set of tests, the post-emergence activity of compounds of this invention was evaluated on the cool season species listed above. Data are presented in Tables 17 and 18. The following procedure was used.

A pre-prepared topsoil mixture (described above) was placed in a pot and compacted to a depth of 1.0 to 1.25 cm from the top of the pot. Seeds of each of several monocotyledonous and dicotyledonous annual plant species were placed on top of the soil The seeds were covered with a mixture of 50% topsoil and 50% Rediearth™ in sufficient quantity to level-fill the pots. The pots were then placed on a greenhouse bench and subirrigated as needed until plants growing from the seeds had emerged and reached a suitable growth stage for post-emergence treatment, typically 9 to 14 days after planting.

A known amount of each test compound dissolved or suspended in an appropriate organic solvent was diluted with a 50:50 mix of acetone and water and applied to the plants by spraying with a standard spray nozzle in a spray volume of 3,100 l/ha at a spray pressure of 511 kPa (30 psig). Control plants were not sprayed.

After treatment the plants were placed in a greenhouse with a 30/21° C. day/night temperature regime and were subsequently watered as needed for growth. Approximately 14 days after treatment, the plants were observed and herbicidal efficacy recorded as percent inhibition by comparison with control plants.

TABLE 17
Post-emergence activity (GR₈₀, g/ha) on dicotyledonous species

| Example | ABUTH | SOLNI | AMARE | DATST | CHEAL | CONAR | PORAL | CIRAR |
|---|---|---|---|---|---|---|---|---|
| 5 | 1000 | 1000 | 250 | 125 | 500 | 750 | 750 | no data |
| 11 | | | phyto | phyto | | no data | | |
| 12 | | | | | | | 1000 | 1000 |
| 34 | phyto | phyto | 750 | 750 | * | * | 250 | 1000 |
| 59 | phyto | phyto | * | phyto | | phyto | | phyto |
| 119 | phyto | phyto | phyto | phyto | | phyto | phyto | no data |
| 124 | phyto | phyto | phyto | phyto | | phyto | phyto | no data |
| 230 | | | phyto | phyto | phyto | phyto | phyto | |
| 231 | | | phyto | * | phyto | phyto | phyto | |
| 243 | phyto | phyto | phyto | 750 | phyto | * | * | no data |
| 244 | phyto | phyto | phyto | phyto | phyto | phyto | | phyto |
| 250 | phyto | phyto | phyto | phyto | phyto | phyto | | |

TABLE 18
Post-emergence activity (GR₈₀, g/ha) on monocotyledonous species

| Example | ECHCG | PANMI | SORHA | SETFA | PANDI | SORVU | BRAPP | DIGSA |
|---|---|---|---|---|---|---|---|---|
| 5 | | | | | | | | |
| 11 | | | | no data | | | | |
| 12 | | | | no data | | | | |
| 24 | phyto | phyto | | | phyto | phyto | phyto | phyto |
| 59 | | | | | phyto | | phyto | phyto |
| 119 | | | | | | | | |
| 124 | | | | | | | | |
| 230 | | | | | | | | phyto |
| 231 | | | phyto | | phyto | phyto | | phyto |
| 243 | | | | | | | | |
| 244 | | | | | | | | phyto |
| 250 | | | | | | | phyto | |

Herbicidal Activity of Racemic Mixture and R- and S-Enantiomers

Pre-emergence herbicidal activity of the compound of Example 5, a racemic mixture of R- and S-enantiomers of N,N′-(1,2-propanediylbis)-3-(trifluoromethyl) benzamide, was compared with that of the individual R- and S-enantiomers, the compounds of Examples 5a and 5b respectively. The procedure was exactly as described above. Rates tested were 1000, 650, 300, 200, 100, 65, 30 and 10 g/ha. As shown in Tables 19 and 20 below, the R-enantiomer was found to have GR₈₀ values that were typically about one-half those of the racemic mixture, and the S-enantiomer was completely inactive. At least for N,N′-(1,2-propanediylbis)-3-(trifluoromethyl)benzamide, therefore, it can be concluded that essentially all the herbicidal activity of the racemic mixture is attributable to the R-enantiomer. It is likely that this generally true for most or all compounds of the present invention.

TABLE 19
Pre-emergence activity (GR₈₀, g/ha) on dicotyledonous species

| Example | ABUTH | SOLNI | AMARE | DATST | CHEAL | CONAR | PORAL | CIRAR |
|---|---|---|---|---|---|---|---|---|
| 5 | * | 300 | 65 | 1000 | 100 | phyto | 650 | * |
| 5a | 650 | 200 | 30 | 650 | 65 | phyto | 30 | 1000 |
| 5b | | | | | | | | |

TABLE 20
Pre-emergence activity (GR₈₀, g/ha) on monocotyledonous species

| Example | ECHCG | PANMI | SORHA | SETFA | PANDI | SORVU | BRAPP | DIGSA |
|---|---|---|---|---|---|---|---|---|
| 5 | phyto | 650 | phyto | phyto | 650 | phyto | phyto | 200 |
| 5a | phyto | 300 | phyto | phyto | 200 | | phyto | 65 |
| 5b | | | | | | | | |

In a later test, R—N,N′-(1,2-propanediylbis)-3-(trifluoromethyl)benzamide was confirmed to have an average pre-emergence GR₈₀ much lower than that of the corresponding racemic mixture. On dicotyledonous species, average GR₈₀ values were 235 g/ha for the R-enantiomer and 535 g/ha for the racemic mixture. On monocotyledonous species, GR₈₀ values were 711 g/ha for the R-enantiomer and 1041 g/ha for the racemic mixture.

Crop Selectivity

Field trials with R—N,N′-(1,2-propanediylbis)-3-(trifluoromethyl)benzamide (the compound of Example Sa) showed that, at pre-emergence application rates giving acceptable control of several weed species, predominantly dicotyledonous species, this compound was not injurious to corn (maize), sorghum or soybeans. Thus acceptable selectivity exists for at least this representative compound of the invention to be used for weed control in these crops. However, R—N,N′-(1,2-propanediylbis)-3-(trifluoromethyl)benzamide was found not to be adequately selective in its herbicidal activity to be useful for weed control in cotton or rice.

Formulations

The herbicidal compositions of this invention, including concentrate formulations which require dilution prior to application, contain at least one herbicidal active ingredient as provided herein and optionally at least one adjuvant in liquid or solid form. Such compositions are prepared by admixing the active ingredient with one or more adjuvants including solvents, diluents, extenders, carriers, and conditioning agents such as wetting agents, emulsifying agents and dispersing agents, to provide finely divided particulate solids, granules, pellets, solutions, or dispersions such as suspensions or emulsions. Thus, it is believed that a herbicidal compound of the invention could be used with an adjuvant such as for example a finely divided solid, an organic liquid, water, a wetting agent, a dispersing agent, an emulsifying agent or any suitable combination of these.

Wetting agents and emulsifying agents useful in compositions of the invention are surfactants, without restriction as to type or chemical class. Nonionic, anionic, cationic and amphoteric types, or combinations of more than one of these types, are all useful in particular situations. The term “alkyl” as conventionally understood in the surfactant art, and as used in the present context, refers to one or more C₈₋₂₂ linear or branched, saturated or unsaturated aliphatic hydrocarbyl moieties. The term “aryl” encompasses a wide range of aromatic moieties including for example phenyl, benzene, toluene, xylene and naphthalene groups.

Hydrophobic moieties of surfactants useful in compositions of the invention can be essentially hydrocarbon based. Alternatively, the hydrophobic moieties can contain silicon atoms, for example in the form of siloxane groups such as heptamethyltrisiloxane groups, or fluorine atoms, for example as partially fluorinated alkyl or perfluoroalkyl chains.

Many surfactants useful herein have a chemical structure that comprises one or more moieties each consisting of a single C₂₋₄ alkylene oxide unit or a polymerized or copolymerized chain of C₂₋₄ alkylene oxide units. Such surfactants are referred to as polyoxyalkylene surfactants and include nonionic, anionic, cationic and amphoteric types. Polyoxyalkylene surfactants useful in presently contemplated compositions contain about 2 to about 100 C₂₋₄ alkylene oxide units.

Anionic surfactants include alkyl and alkylaryl carboxylates, alkyl and alkylaryl polyoxyalkylene ether carboxylates, alkyl and alkylaryl sulfates and sulfonates, alkyl and alkylaryl polyoxyalkylene ether sulfates and sulfonates, naphthalene sulfonates and formaldehyde condensates thereof, petroleum sulfonates, sulfonated vegetable oils, sulfosuccinate and semisulfosuccinate esters, sulfosuccinamates, isethionates, taurates, sarcosinates, alkyl and alkylaryl phosphates, and alkyl and alkylaryl polyoxyalkylene phosphates.

Nonionic surfactants include polyoxyethylene alkyl and alkylaryl ethers, such as polyoxyethylene primary and secondary alcohols, polyoxyethylene alkylphenols and polyoxyethylene acetylenic diols, polyoxyethylene alkyl esters, such as ethoxylated fatty acids, polyoxyethylene polyoxypropylene block copolymers, polyoxyethylene sorbitan alkyl esters, glyceryl alkyl esters, sucrose esters, and alkyl polyglycosides.

Cationic surfactants include polyoxyethylene tertiary alkylamines and alkenylamines, such as polyoxyethylene fatty amines, quaternary ammonium surfactants and polyoxyethylene alkyletheramines, imidazolines and pyridines.

Amphoteric surfactants, encompassing as is customary in the art surfactants more correctly described as zwitterionic, include polyoxyethylene alkylamine oxides, alkylbetaines, phosphatidylcholines, phosphatidylethanolamines, and alkyl-substituted amino acids.

Standard reference sources from which one of skill in the art can select suitable surfactants, without limitation to the above mentioned classes, include Handbook of Industrial Surfactants, Second Edition (1997) published by Gower, McCutcheon 's Emulsifiers and Detergents, North American and International Editions (1997) published by MC Publishing Company, and International Cosmetic Ingredient Dictionary, Sixth Edition (1995) Volumes 1 and 2, published by the Cosmetic, Toiletry and Fragrance Association.

Dispersing agents useful in compositions of the invention include methyl cellulose, polyvinyl alcohol, sodium lignin sulfonates, polymeric alkyl naphthalene sulfonates, sodium naphthalene sulfonate, and polymethylene bisnaphthalene sulfonate.

Compounds of the invention can be formulated for practical use as any suitable liquid or solid formulation type, including without restriction an emulsifiable concentrate, emulsifiable gel, water-in-oil emulsion, oil-in-water emulsion, water-in-oil-in-water (multiple) emulsion, microemulsion, suspension concentrate, suspoemulsion, wettable powder, emulsifiable granule, water-dispersible granule, dust, granule, tablet or briquette.

In an emulsifiable concentrate, a compound of the invention is dissolved in a suitable organic solvent that is itself normally of low solubility in, or miscibility with, water. Also included is a system of one or more emulsifying agents selected to promote rapid and acceptably stable emulsification when the concentrate is diluted in water prior to application. Alternatively but more rarely, the concentrate can be diluted in an organic liquid such as kerosene for application. Emulsifiable concentrates are liquid, but if desired they can be processed to form an emulsifiable gel by methods known in the art. Suitable organic solvents for a compound of the invention illustratively include N,N-dimethylformamide, dimethylsulfoxide (DMSO), N-methylpyrrolidone, hydrocarbons, and water-immiscible ethers, esters and ketones.

Emulsions (whether water-in-oil or oil-in-water) comprise an aqueous phase and an oil phase. Typically a compound of the invention is dissolved in an organic solvent of low solubility in water, to form the oil phase. The aqueous phase can optionally contain a water-soluble active ingredient such as a glyphosate salt. The oil phase can be continuous (water-in-oil) or discontinuous (oil-in-water); in either case the emulsion is stabilized by means of a system of one or more emulsifying agents. In preparing a water-in-oil-in-water emulsion, a water-in-oil emulsion is first prepared having a compound of the invention in the oil phase, together with a first emulsifying system as described immediately above. This water-in-oil emulsion is then itself dispersed in an aqueous medium using a second emulsifying system. Either the internal or the external aqueous phase so formed, or both such phases, can optionally contain a water-soluble active ingredient.

In a suspension concentrate, a compound of the invention is present in the form of a fine particulate solid, dispersed with the aid of dispersing agents in a liquid, preferably aqueous, medium to form a stable suspension. A suspoemulsion has both a discontinuous oil phase emulsified in an aqueous medium and a discontinuous solid particulate phase dispersed in the same aqueous medium; a compound of the invention can be present in either the oil phase or the particulate phase. A second water-insoluble active ingredient can optionally be present in the same or the other discontinuous phase. In both suspension concentrates and suspoemulsions, a water-soluble active ingredient such as a salt of glyphosate can optionally be present in the aqueous phase.

Liquid concentrate formulations of the invention, such as the types mentioned immediately above, contain about 0.1% to about 60%, preferably about 5% to about 50%, by weight of a compound of the invention. In the case of an emulsifiable concentrate, the upper limit is determined by the solubility limit of the compound in the selected solvent. In the case of an emulsion or suspension concentrate, the upper limit is determined primarily by the limit of colloidal stability of the composition.

Wettable powders are water-dispersible fine particulate solid compositions comprising a compound of the invention, typically with an inert solid extender and one or more wetting and/or dispersing agents. The extender is usually of mineral origin such as for example a natural clay, diatomaceous earth, or a synthetic mineral derived from silica. Illustrative examples of such extenders include kaolinite, attapulgite clay and synthetic magnesium silicate. Wettable powder compositions of the invention usually contain about 0.5% to about 60%, preferably about 5% to about 20%, by weight of a compound of the invention, about 0.25% to about 25%, preferably about 1% to about 15%, by weight of wetting agent(s), about 0.25% to about 25%, preferably about 1% to about 15%, by weight of dispersing agent(s), and about 5% to about 95%, preferably about 5% to about 50%, by weight of an inert solid extender. Where required, about 0.1% to about 2% by weight of the composition can be comprised of a corrosion inhibitor or anti-foaming agent or both.

Water-dispersible granule formulations of the invention have similar ingredients to the wettable powders just mentioned, but in such formulations the fine solid particles are agglomerated to form larger aggregates that are less dusty and more convenient to handle. Any of a variety of granulation techniques known in the art can be used in preparing such formulations, including without restriction spray drying, pan granulation, extrusion granulation and fluid bed agglomeration. The extrusion process described in United Kingdom Patent Application No. 1 433 882 is one illustrative process that can be useful in preparing granular compositions of the present invention.

Dry formulations for direct application to soil without dilution in water include dusts and granules. Granules of the invention are physically stable particulate compositions comprising a compound of the invention adsorbed on or distributed through a matrix formed of an inert, finely divided particulate extender. In order to aid leaching of the compound of the invention from the granules, a surfactant can be present in the composition. Natural clays, pyrophyllites, illite and vermiculite are examples of operable classes of particulate mineral extenders. Preferred extenders are porous, adsorptive, preformed particulates such as preformed and screened particulate attapulgite; heat-expanded, particulate vermiculite; or finely divided clays including kaolin, hydrated attapulgite or bentonite.

Granular compositions of the invention typically contain about 0.1 to about 30 parts by weight of a compound of the invention and 0 to about 5 parts by weight of surfactant per 100 parts by weight of extender.

Compositions of the invention can also contain other ingredients, for example fertilizers, other herbicides, other pesticides, safeners, etc.

Fertilizers useful in combination with a compound of the invention include ammonium nitrate, urea, potash and superphosphate fertilizers. Other useful additives include materials in which plant organisms take root and grow such as compost, manure, humus, sand, etc.

Combinations with Other Herbicides

Among herbicides that can be formulated and/or applied together with a compound of the invention are acetochlor, acifluorfen, aclonifen, alachlor, ametryn, amidosulfuron, anilofos, asulam, atrazine, azafenidin, azimsulfuron, benazolin, benfluralin, benfuresate, bensulfuron-methyl, bensulide, bentazon, benzofenap, bialaphos, bifenox, bromobutide, bromofenoxim, butachlor, butamifos, butralin, butroxydim, butylate, cafenstrole, carbetamide, carfentrazone-ethyl, chlomethoxyfen, chlorbromuron, chloridazon, chlorimuron-ethyl, chlorotoluron, chlomitrofen, chlorotoluron, chlorpropham, chlorsulfuron, chlorthal-dimethyl, chlorthiamid, cinmethylin, cinosulfuron, clethodim, clodinafop-propargyl, clomazone, clomeprop, clopyralid, cloransulam-methyl, cyanazine, cycloate, cyclosulfamuron, cycloxydim, cyhalofop-butyl, 2,4-D, daimuron, dalapon, 2,4-DB, desmedipham, desmetryn, dicamba, dichlobenil, dichlorprop, diclofop-methyl, diflufenican, dimefuron, dimepiperate, dimethachlor, dimethametryn, dimethenamid, dinitramine, dinoterb, diphenamid, diquat, dithiopyr, diuron, EPTC, esprocarb, ethalfluralin, ethametsulfuron-methyl, ethofumesate, ethoxysulfuron, etobenzanid, fenoxaprop-ethyl, fenuron, flamprop-methyl, fenoxaprop, flazasulfuron, fluazifop-butyl, fluchloralin, flumetsulam, flumiclorac-pentyl, flumioxazin, fluometuron, fluorochloridone, fluoroglycofen-ethyl, flupoxam, flurenol, fluridone, fluroxypyr-1-methylheptyl, flurtamone, fluthiacet-methyl, fluroxypyr, fomesafen, fosamine, glufosinate, glyphosate, halosulfuron, haloxyfop-methyl, hexazinone, imazameth, imazamethabenz, imazamox, imazapic, imazapyr, imazaquin, imazethapyr, imazosulfuron, indanofan, isoproturon, isouron, isoxaben, isoxaflutole, isoxapyrifop, lactofen, lenacil, linuron, MCPA, MCPB, mecoprop, mefenacet, metamitron, metazachlor, methabenzthiazuron, methylarsonic acid, methyldymron, metobenzuron, metobromuron, metolachlor, metosulam, metoxuron, metribuzin, metsulfuron, molinate, monolinuron, naproanilide, napropamide, naptalam, neburon, nicosulfuron, nonanoic acid, norflurazon, orbencarb, oryzalin, oxadiargyl, oxadiazon, oxasulfuron, oxyfluorfen, paraquat, pebulate, pendimethalin, pentanochlor, pentoxazone, phenmedipham, picloram, piperophos, pretilachlor, primisulfuron, prodiamine, prometon, prometryn, propachlor, propanil, propaquizafop, propazine, propham, propisochlor, propyzamide, prosulfocarb, prosulfuron, pyraflufen-ethyl, pyrazolynate, pyrazosulfuron-ethyl, pyrazoxyfen, pyributicarb, pyridate, pyriminobac-methyl, quinclorac, quinmerac, quizalofop-ethyl, rimsulfuron, sethoxydim, siduron, simazine, simetryn, sulcotrione, sulfamic acid, sulfentrazone, sulfometuron, sulfosulfuron, 2,3,6-TBA, TCA, tebutam, tebuthiuron, terbacil, terbumeton, terbuthylazine, terbutryn, thenylchlor, thiazopyr, thifensulfuron, thiobencarb, tiocarbazil, tralkoxydim, triallate, triasulfuron, tribenuron, triclopyr, trietazine, trifluralin, triflusulfuron and vernolate.

Herbicides useful in combination with a compound of the invention can be selected from those listed in standard reference works such as The Pesticide Manual, 11th Edition, British Crop Protection Council (1997), and Farm Chemicals Handbook '97, Meister Publishing Company (1997).

Herbicides particularly useful in combination with a compound of the invention include a-chloroacetamide herbicides, for example acetochlor, alachlor and metolachlor, for pre-emergence application, and glyphosate for post-emergence application.

In a greenhouse pre-emergence test conducted according to the procedure described hereinabove, R—N,N′-(1,2-propanediylbis)-3-(trifluoromethyl)benzamide (the compound of Example 5a) was applied at 200 g/ha and acetochlor was applied at 100 g/ha, both individually and in combination. A greater than expected herbicidal activity was noted from the combination application at least on ABUTH, DATST, SORHA and PANMI, as shown in Table 21 below. Of the 14 species included in the test, 4 showed >85% control with the compound of Example 5a alone, 7 showed >85% control with acetochlor alone, and 11 showed >85% control with the combination. The data of Table 21 are indicative of a synergistic interaction between acetochlor and the compound of Example 5a.

TABLE 21
Percent control by pre-emergence application

| | Example 5a | Acetochlor | 5a + acetochlor |
|---|---|---|---|
| Species | 200 g/ha | 100 g/ha | 200 + 100 g/ha |
| ABUTH | 8 | 0 | 42 |
| CONAR | 22 | 23 | 35 |
| AMARE | 100 | 100 | 100 |
| CHEAL | 100 | 100 | 100 |
| CIRAR | 35 | 100 | 100 |
| DATST | 41 | 33 | 100 |
| POROL | 100 | 100 | 100 |
| SOLNI | 100 | 75 | 100 |
| BRAPP | 15 | 76 | 76 |
| SORHA | 30 | 83 | 93 |
| DIGSA | 82 | 100 | 100 |
| PANDI | 55 | 100 | 100 |
| PANMI | 20 | 83 | 95 |
| SETFA | 40 | 100 | 100 |

In the same greenhouse pre-emergence test, R-2-fluoro-3-trifluoromethyl-N-[1-methyl-2-(3-trifluoromethyl)phenylcarbonylamino]ethylbenzamide (the compound of Example 13) was applied at 100 g/ha and acetochlor was applied at 100 g/ha, both individually and in combination. A greater than expected herbicidal activity was noted from the combination application at least on ABUTH, DATST, SOLNI and PANMI, as shown in Table 22 below. Of the 14 species included in the test, 3 showed >85% control with the compound of Example 13 alone, 7 showed >85% control with acetochlor alone, and 10 showed >85% control with the combination. The data of Tables 21 and 22 are indicative of a synergistic interaction between acetochlor and compounds of the invention.

TABLE 22
Percent control by pre-emergence application

| | Example 13 | Acetochlor | 13 + acetochlor |
|---|---|---|---|
| Species | 100 g/ha | 100 g/ha | 100 + 100 g/ha |
| ABUTH | 2 | 0 | 20 |
| CONAR | 38 | 23 | 32 |
| AMARE | 86 | 100 | 100 |
| CHEAL | 95 | 100 | 100 |
| CIRAR | 25 | 100 | 100 |
| DATST | 12 | 33 | 66 |
| POROL | 100 | 100 | 100 |
| SOLNI | 45 | 75 | 95 |
| BRAPP | 4 | 76 | 80 |
| SORHA | 7 | 83 | 88 |
| DIGSA | 43 | 100 | 100 |
| PANDI | 40 | 100 | 100 |
| PANMI | 5 | 83 | 95 |
| SETFA | 25 | 100 | 100 |

In a greenhouse post-emergence test conducted according to the procedure described hereinabove, R-2-fluoro-3-trifluoromethyl-N-[1-methyl-2-(3-trifluoromethyl)phenylcarbonylamino]ethylbenzamide (the compound of Example 13) was applied at 0, 64, 125 and 250 g/ha in combination with glyphosate isopropylammonium salt at 1000 g a.e./ha. The glyphosate herbicide alone gave 72% control of dicotyledonous species and 84% control of monocotyledonous species. Addition of the compound of Example 13 at 64 g/ha increased control to 85% and 89% respectively, and at 125 g/ha to 95% and 89% respectively. At 250 g/ha, addition of the compound of Example 13 gave 93% control of dicotyledonous species, but reduced control of monocotyledonous species to 73%.

It is contemplated that compounds of the invention, when used together with a glyphosate herbicide, can enhance the symptoms of phytotoxicity by comparison with glyphosate alone; results of the test described immediately above indicate that a further unexpected benefit of such combination treatments is synergistic enhancement of weed control, particularly in the case of dicotyledonous species.

Application

In accordance with the present invention, a herbicidally effective amount of a compound of the invention is applied to soil containing seeds or vegetative propagules of a plant species to be killed or controlled. The compound can be applied to the soil surface or can be incorporated into the soil in any convenient fashion. The application of liquid and particulate solid compositions of the invention to soil can be carried out by conventional methods, e.g., by spraying with a hydraulic sprayer or spinning disk applicator, by dusting or by use of a granule applicator. Application can be made by hand-carried, backpack or ground-travelling equipment. Compounds of the invention are also suitable for application from airplanes as a dust or spray because of their effectiveness at low dosages.

The exact amount of active ingredient to be employed is dependent on various factors, including plant species and stage of development thereof, type and condition of soil, amount of rainfall and the specific compound employed. In selective pre-emergence application to soil, a dosage of about 0.02 to about 11.2 kg/ha, preferably from about 0.1 to about 5.60 kg/ha, is usually employed. Lower or higher rates may be useful in some instances. One skilled in the art can readily determine from this specification, including the above examples, and by routine experimentation a suitable rate to be applied in any particular case.

The term “soil” is employed herein in its broadest sense to be inclusive of all conventional “soils” as defined in Webster's New International Dictionary, Second Edition, Unabridged (1961). Thus, the term refers to any substance or medium in which vegetation may take root and grow, and includes not only earth but also compost, manure, muck, humus, sand, etc. adapted to support plant growth. In common with most soil-applied herbicides, compounds of the invention can be expected to provide greater pre-emergence herbicidal performance on soils of low organic matter or clay content than on soils having a higher organic matter or clay content.

While illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth hereinabove but rather that the claims be construed as including all features which would be treated as equivalents thereof by those skilled in the art to which the invention pertains.

What is claimed is:

1. A compound having the formula (I) 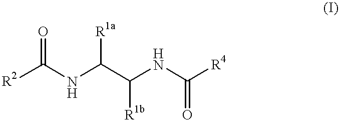
wherein
(a) one of R^{1a} and R^{1b} is a methyl, hydroxymethyl or monohalomethyl group and the other is hydrogen;
(b) R² is a group R³—(X¹)ₘ— where X¹ is a methylene, oxy or thio linkage, m is 0 or 1, and R³ is a substituted phenyl group of formula 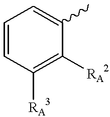
where R_{A}² is a hydrogen, halogen or methyl group and R_{A}³ is a halogen or halomethyl group; and
(c) R⁴ is an α-halo- or α,α-dihalo-(C₁₋₃)alkyl group, or a group having the formula —(X²)ₙ—R⁵ where X² is a methylene, oxy or thio linkage, n is 0 or 1, and R⁵ is a first five-member or six-member aromatic or heterocyclic ring, said ring having
(1) ring substituents selected from the following list A: (i) hydrogen, (ii) halogen, (iii) cyano, (iv) nitro and (v) C₁₋₆ aliphatic and alicyclic hydrocarbyl and halohydrocarbyl, phenyl, benzyl, phenylethyl and five-member or six-member heterocyclic groups attached to the first aromatic or heterocyclic ring either directly or by an oxy or thio linkage; wherein such phenyl, benzyl, phenylethyl or heterocyclic groups have ring-substituents selected from hydrogen, halogen, methyl, halomethyl, methoxy, methylthio, halomethoxy and halomethylthio groups; and/or
(2) fused therewith a second five-member or six-member aromatic or heterocyclic ring having ring substituents selected from list A as defined above;
with the proviso that no more than one ring substituent on the first and second five-member or six-member aromatic or heterocyclic rings is other than a hydrogen, halogen, methyl, methoxy or methylthio group.

2. A compound of claim 1 wherein R^{1a} is hydrogen and R^{1b} is a methyl group.

3. A compound of claim 1 wherein R⁴ is a group selected either from α-halo- and α,α-dihalo-(C₁₋₃)alkyl groups, or from groups having the formula —(X²)ₙ—R⁷ where X² is a methylene, oxy or thio linkage, n is 0 or 1, and R⁷ is
(a) a first aromatic or heterocyclic ring having the formula 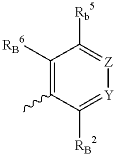
where
(1) Y is N or CR_{B}³ where R_{B}³ (i) is a hydrogen, cyano or nitro group; (ii) is a group selected from the following list B: halogen and C₁₋₆ aliphatic and alicyclic hydrocarbyl and halohydrocarbyl, phenyl, benzyl, phenylethyl and pyrazol-3-yl groups attached to the first aromatic or heterocyclic ring either directly or by an oxy or thio linkage, wherein such phenyl, benzyl or phenylethyl groups have ring substituents selected from hydrogen, halogen and methyl groups, no more than two such ring substituents being other than hydrogen and at least one o-substituent being hydrogen, and wherein such pyrazol-3-yl groups have the formula 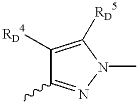
where one of R_{D}⁴ and R_{D}⁵ is a hydrogen or halogen group and the other is a halogen, methyl or halomethyl group; or (iii) forms with the adjacent moiety R_{B}² a second aromatic or heterocyclic ring, fused to the first aromatic or heterocyclic ring, this second ring being either a dihydrofuran ring or a phenyl or thiazole ring having substituents selected from hydrogen, halogen, methyl, ethyl, halomethyl, haloethyl, methoxy and ethoxy groups;
(2) Z is N or CR_{B}⁴ where R_{B}⁴ is a hydrogen, fluoro, chloro, fluoromethyl, chloromethyl or, except where n is 0, methyl, methoxy, fluoromethoxy or chloromethoxy group, with the proviso that no more than one of Y and Z is N;
(3) one of R_{B}² and R_{B}⁶ is hydrogen and the other is hydrogen or a group selected from list B as defined above; or R_{B}⁶ is hydrogen and R_{B}² forms with R_{B}³ a second aromatic or heterocyclic ring fused to the first aromatic or heterocyclic ring as defined above; and
(4) R_{B}⁵ is a hydrogen, fluoro or, where Z is N, chloro group;
with the proviso that no more than one of R_{B}², R_{B}³, R_{B}⁴, R_{B}⁵ and R_{B}⁶ comprises a phenyl or pyrazolyl ring, no more than one of R_{B}², R_{B}³, R_{B}⁴, R_{B}⁵ and R_{B}⁶ is a halomethyl group and, where n is 0, at least one of R_{B}², B_{B}³, B_{B}⁴, B_{B}⁵ and R_{B}⁶ is other than hydrogen;
(b) a pyrazol-4-yl or 1,2,3-triazol-4-yl ring having the formula 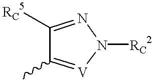
where V is N or CH, R_{C}² is a methyl or phenyl group and R_{C}⁵ is a group selected from list B as defined above with the proviso that where R_{C}² is methyl, R_{C}⁵ is other than a halogen or methyl group;
(c) an optionally substituted pyrazol-3-yl ring having the formula 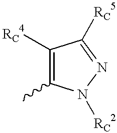
where R_{C}² is a methyl or phenyl group, one of R_{C}⁴ and R_{C}⁵ is a hydrogen or halogen group and the other is a group selected from list B as defined above with the proviso that where R_{C}² is methyl, one of R_{C}⁴ and R_{C}⁵ is other than a hydrogen, halogen or methyl group;
(d) an isoxazol-4-yl ring having the formula 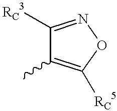
where one of R_{C}³ and R_{C}⁵ is a halomethyl group and the other is a group selected from list B as defined above but is not a halogen or methyl group;
(e) an oxazol-4-yl ring having the formula 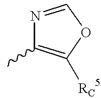
where R_{C}⁵ is a phenyl, benzyl or phenylethyl group having ring-substituents selected from hydrogen, halogen, methyl and halomethyl groups, no more than two such ring-substituents being other than hydrogen and at least one o-substituent being hydrogen; or
(f) a 1,3-thiazol-5-yl or 1,2,3-thiadiazol-5-yl ring having the formula 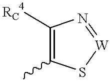
where W is N or CR_{C}² where R_{C}² is a group selected from list B as defined above, and R_{C}⁴ is a halogen, methyl or halomethyl group.

4. A compound of claim 3 wherein R^{1a} is hydrogen and R^{1b} is a methyl group.

5. A compound of claim 3 wherein R² is a group 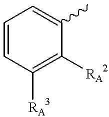
where R_{A}² is hydrogen, fluorine or chlorine and R_{A}³ is fluorine, chlorine or a trifluoromethyl group.

6. A compound of claim 5 wherein R_{A}² is hydrogen or fluorine and R_{A}³ is a trifluoromethyl group.

7. A compound of claim 5 wherein R_{A}² and R_{A}³ are each chlorine.

8. A compound of claim 3 wherein R⁴ is selected from
(a) an α-halo- or α,α-dihalo-(C₁₋₃)alkyl group;
(b) a substituted phenyl ring having the formula 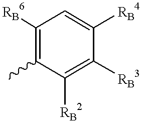
where
(1) R_{B}³ is (i) a group selected from hydrogen, halogen, cyano, nitro, methyl, halomethyl, phenyl, methoxy, methylthio, isobutoxy, halomethoxy, haloethoxy, phenoxy and pyrazol-3-yloxy groups, such pyrazol-3-yloxy groups comprising a substituted pyrazol-3-yl ring having the formula 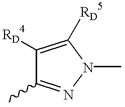
where one of R_{D}⁴ and R_{D}⁵ is a halogen group and the other is a halomethyl group; or (ii) forms with R_{B}² a dihydrofuran, optionally halogen-substituted phenyl, or thiazole ring fused to the phenyl ring;
(2) R_{B}⁴ is a hydrogen, halogen or trifluoromethyl group; and
(3) one of R_{B}² and R_{B}⁶ is hydrogen and the other is a group selected from hydrogen, halogen, methyl, halomethyl, phenyl, benzyl, phenylethyl, C₁₋₄ hydrocarbyloxy, hydrocarbylthio and halohydrocarbylthio, optionally 4-chloro- or 4-methyl-substituted phenoxy and phenylthio, benzoxy and pyrazol-3-yloxy groups, such pyrazol-3-yloxy groups comprising a substituted pyrazol-3-yl ring having the formula shown above; or R_{B}⁶ is hydrogen and R_{B}² forms with R_{B}³ said dihydrofuran, optionally halogen-substituted phenyl, or thiazole ring fused to the phenyl ring;
(c) a group having the formula —X²—R⁷ where X² is a methylene or oxy linkage and R⁷ is a substituted or unsubstituted phenyl ring having the formula 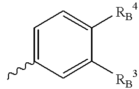
where R_{B}³ is a hydrogen, methoxy or trifluoromethyl group and R_{B}⁴ is a hydrogen or halogen group;
(d) a substituted pyridine ring having the formula 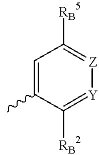
where
(1) if Z is N, Y is CR_{B}³ where R_{B}³ is a chloro or methyl group or forms with R_{B}² a phenyl ring fused to the pyridine ring, R_{B}², except where it forms part of such phenyl ring, is hydrogen, and R_{B}⁵ is a hydrogen or chloro group; and
(2) if Y is N, Z is CR_{B}⁴ where R_{B}⁴ is a hydrogen or chloro group, R_{B}² is selected from hydrogen, chloro, C₁₋₄ alkoxy, C₁₋₄ hydrocarbylthio and optionally 4-chloro- or 4-methyl-substituted phenoxy and phenylthio groups, and R_{B}⁵ is a hydrogen, chloro or bromo group, with the proviso that, except where R_{B}² and R_{B}⁵ are both chloro groups, only one of R_{B}², R_{B}⁴ and R_{B}⁵ is other than hydrogen;
(e) a substituted pyrazol-4-yl or 1,2,3-triazol-4-yl ring having the formula 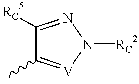
where V is N or CH, R_{C}² is a methyl or phenyl group and R_{C}⁵ is a methyl or halomethyl group;
(f) a substituted pyrazol-3-yl ring having the formula 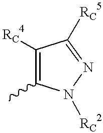
where R_{C}² is a methyl or phenyl group, R is a hydrogen or halogen group and R_{C}⁵ is a methyl, halomethyl or tert-butyl group;
(g) a substituted isoxazol-4-yl ring having the formula 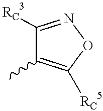
where R_{C}³ is a methyl or halomethyl group and R_{C}⁵ is a chloro, ethyl or optionally halogen- or halomethyl-substituted phenyl group;
(h) a substituted oxazol-4-yl ring having the formula 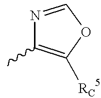
where R_{C}⁵ is a methyl or halomethyl group; and
(i) a substituted 1,3-thiazol-5-yl or 1,2,3-thiadiazol-5-yl ring having the formula 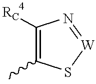
where, if W is N, R_{C}⁵ is a methyl group; and if W is CR_{C}², R_{C}² is a halogen, methyl, isopropyl, phenyl, halomethyl or methoxy group and R_{C}⁴ is a halogen, methyl or trifluoromethyl group.

9. A compound of any of claims 1 to 8 that is an R-enantiomer or a racemic mixture of R- and S-enantiomers.

10. A compound of claim 3 wherein R² is a group 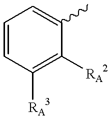
where R_{A}² is hydrogen, fluorine or chlorine and R_{A}³ is fluorine, chlorine or a trifluoromethyl group; and R⁴ is a group 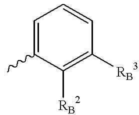
where R_{B}² is hydrogen, fluorine or chlorine and R_{B}³ is fluorine, chlorine or a trifluoromethyl group.

11. A compound of claim 10 that is an R-enantiomer.

12. A compound useful as an intermediate in preparation of herbicides, having the formula 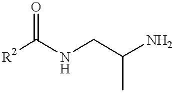
wherein R² is a group R³—(X¹)ₘ— where X¹ is a methylene, oxy or thio linkage, m is 0 or 1, and R³ is a substituted phenyl group of formula 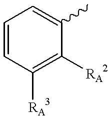
wherein R_{A}² is a hydrogen, halogen or methyl group and R_{A}³ is a halogen or halomethyl group.

13. A process for preparing a compound of claim 2, comprising a first step of reacting 1,2-diaminopropane with a compound having the formula 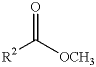
wherein R² is a group R³—(X¹)ₘ— where X¹ is a methylene, oxy or thio linkage, m is 0 or 1, and R³ is a substituted phenyl group of formula 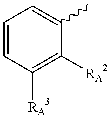
where R_{A}² is a hydrogen, halogen or methyl group and R_{A}³ is a halogen or halomethyl group, to form an intermediate compound having the formula 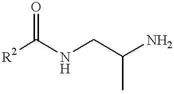
and a second step of reacting said intermediate compound with a compound having the formula 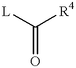
where L is a suitable leaving group and R⁴ is an α-halo- or α,α-dihalo-(C₁₋₃)alkyl group, or a group having the formula —(X²)ₙ—R⁵ where X² is a methylene, oxy or thio linkage, n is 0 or 1, and R⁵ is a first five-member or six-member aromatic or heterocyclic ring, said ring having
(1) ring-substituents selected from the following list A: (i) hydrogen, (ii) halogen, (iii) cyano, (iv) nitro and (v) C₁₋₆ aliphatic and alicyclic hydrocarbyl and halohydrocarbyl, phenyl, benzyl, phenylethyl and five-member or six-member heterocyclic groups attached to the first aromatic or heterocyclic ring either directly or by an oxy or thio linkage; wherein such phenyl, benzyl, phenylethyl or heterocyclic groups have ring-substituents selected from hydrogen, halogen, methyl, halomethyl, methoxy, methylthio, halomethoxy and halomethylthio groups; and/or
(2) fused therewith a second five-member or six-member aromatic or heterocyclic ring having ring-substituents selected from list A as defined above;
with the proviso that no more than one ring-substituent on the first and second five-member or six-member aromatic or heterocyclic rings is other than a hydrogen, halogen, methyl, methoxy or methylthio group; to form said compound of claim 2.

14. The process of claim 13 wherein L is selected from —OH, —OCH₃ and —Cl groups.

15. A process for preparing a compound of claim 2 that is an R-enantiomer, comprising a first step of converting benzyloxycarbonyl-D-alanine methyl ester to a first intermediate compound having the formula 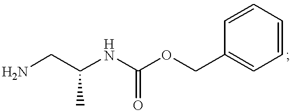
a second step of reacting said first intermediate compound with a compound having the formula 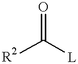
where L is a suitable leaving group and R² is as defined above, to form a second intermediate compound having the formula 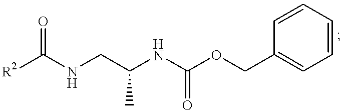
a third step of hydrogenating said second intermediate compound to form a third intermediate compound having the formula 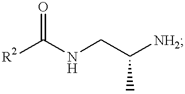
and a fourth step of reacting said third intermediate compound with a compound having the formula 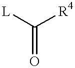
where L is a suitable leaving group and R⁴ is as defined above, to form said compound of claim 2 that is an R-enantiomer.

16. The process of claim 15 wherein L is selected from —OH, —OCH₃ and —Cl groups.

17. A composition for application to plants or the locus thereof as a herbicide, plant growth regulator or elicitor of symptoms of phytotoxicity, comprising a compound of claim 3 and an agriculturally acceptable liquid carrier.

18. The composition of claim 17, further comprising an α-chloroacetamide herbicide.

19. The composition of claim 17, further comprising a glyphosate herbicide.

20. A method of killing, controlling growth of or eliciting symptoms of phytotoxicity in plants, comprising applying a herbicidally effective amount of a compound of claim 3 to said plants or to the locus thereof.
